(19) United States
(12) Patent Application Publication
(10) Pub. No.: US 2005/0014882 A1
(43) Pub. Date: Jan. 20, 2005

(54) Aqueous systems containing additive pre-mixes and processes for forming the same

(76) Inventors: Clement Linus Brungardt, Oxford, PA (US); Charles Lee Burdick, Landenberg, PA (US); Renee Michele Gavas, Middletown, DE (US)

Correspondence Address: HERCULES INCORPORATED;HERCULES PLAZA, 1313 NORTH MARKET STREET, WILMINGTON, DE, 19894-0001, US

(21) Appl. No.: 10/837,442

(22) Filed: Apr. 30, 2004

Related U.S. Application Data
(60) Provisional application No. 60/467,802, filed on May 2, 2003.
(60) Provisional application No. 60/470,762, filed on May 15, 2003.

(51) Int. Cl. D21H 19/00; C08K 3/34

(52) U.S. Cl. 524/445; 162/135; 524/492

(57) ABSTRACT

The present invention relates to an additive for pigmented aqueous systems comprising a mixture of a cationic polymer and a high surface area anionic inorganic particle, methods for making and using the additive, methods of forming an aqueous paper coating color as well as a cellulose matrix coated therewith; and a process for preparing stabilized pre-mixes.

This application claims the benefit of U.S. Provisional Application No. 60/467,802 filed May 2, 2003 and U.S. Provisional Application No. 60/470,762 filed May 15, 2003, each of which is incorporated by reference herein in its entirety.

### BACKGROUND OF THE INVENTION

1. Field of the Invention

The present invention generally relates to aqueous systems containing additive pre-mixes and processes for forming the same wherein the additive for pigmented aqueous systems comprises a mixture of a cationic polymer and an anionic particle, methods of forming an aqueous paper coating color as well as a cellulose matrix coated therewith; and a processes for preparing stabilized pre-mixes.

2. Description of Background and Other Information

For more than 100 years, pigmented coatings have been used to improve the optical properties and printability of paper. Pigments in the coatings, and the pore spaces they form, are known to increase paper opacity, brightness, ink receptivity, and gloss. The smooth surface formed by calendering the coated paper has higher gloss and is easier to print on than the relatively rough uncoated base sheet.

The use of cationic polymers and cationic pigments in paper coating applications is known in the art. For example, articles such as LePoutre, P., “The structure of paper coatings: an update”, Progress in Organic Coating, 17, pages 89-106 (1989) and Lepoutre, P. et al., “The light-scattering efficiency of microvoids in paper coatings and filled papers,” Journal of Pulp and Paper Science, 15, #5, pages 183-185, September 1989, describe the use of cationic polymers, amphoteric polymers, and a latex containing an amphoteric polymer at its surface in controlling the immobilization of coating solids and increasing the void fraction of the dried coating. These cationic additives interact strongly with the anionic coating pigments, creating a porous structure that scatters light more efficiently, and has more exposed pigment surface area, than a standard paper coating. Increasing light scattering increases the opacity and brightness of the coating. Increasing pigment surface area increases ink receptivity. However, pigment shock problems (the formation of gels and hard aggregates) have blocked the commercial use of cationic polymer additives in paper coating applications.

The use of cationic pigments and cationic polymers in papermaking applications has been discussed in many articles and patents for example, as described in U.S. Pat. No. 2,795,545 (Gluesenkamp); U.S. Pat. No. 3,804,656 (Kaliski et al.); U.S. Pat. No. 5,718,756 (Mohler); U.S. Pat. No. 4,738,726 (Pratt); von Raven A., Scritmatter, G., Weigl, J., “Cationic coating colors—a new coating system, TAPPI Journal, December 1998, pages 141-148; U.S. Pat. No. 4,874,466 (Savino); U.S. Pat. No. 4,964,955 (Lamar); and U.S. Pat. No. 5,169,441 (Lauzon).These articles and patents are limited to the direct addition of a cationic polymer or treatment of a large portion of the aqueous pigment with a relatively low addition level of cationic polymer followed by high shear mixing, which results in agglomeration.

The present invention addresses the need within the industry to provide a process(es), and additive(s) used therein, which results in reduced pigment shock, greater ease of use, and greater process flexibility.

### SUMMARY OF THE INVENTION

The present invention relates to embodiments of a pigmented aqueous system comprising an additive pre-mix comprising a cationic polymer and an anionic particle (e.g. a high surface area, anionically charged inorganic mineral or synthetic particle and/or mixtures thereof).

The present invention further relates to forming an aqueous system (e.g. aqueous paper coating color) comprising:
(1) mixing the anionic particle and the cationic polymer; wherein an addictive pre-mix is formed,
(2) optionally filtering the additive pre-mix;
(3) optionally adding a stabilizing agent to the additive pre-mix;
(4) optionally adding the additive pre-mix to a coating starch;
(5) optionally adding a biocide to the additive pre-mix; and
(6) adding the additive pre-mix to an aqueous system.

Still further, the present invention includes coating a cellulose matrix in accordance with the process described above, as well as the coated cellulose matrix, further including the steps of
(7) coating a cellulose matrix; and
(8) drying the cellulose matrix.

Still further, the present invention relates to embodiments of a process for preparing a stable pre-mix comprising:
(a) forming a pre-mix comprising an anionic particle and a cationic polymer;
(b) adding a stabilizing agent to the pre-mix, wherein a stable pre-mix is formed; and
(c) optionally adding a biocide to the stable pre-mix.

Additionally the present invention relates to a stable pre-mix produced using the above-noted process.

### BRIEF DESCRIPTION OF THE DRAWINGS

FIG. 1 depicts the relationship between cationic polymer concentration and pigment shock.

FIG. 2 depicts the relationship between coating viscosity and the pre-mix addition concentration.

FIG. 3 depicts the relationship between the coating weight and the opacity.

FIG. 4 depicts the relationship between the coating weight and the brightness.

FIG. 5 depicts the relationship between the pre-mix addition concentration and opacity.

FIG. 6 depicts the relationship between the addition concentration and brightness.

FIG. 7 depicts the relationship between the post dilution stirring time and pigment shock.

FIG. 8 depicts the relationship between the pre-mix addition level and the immobilization of solids.

### DETAILED DESCRIPTION OF THE INVENTION

All references, particularly U.S. patents, cited in this disclosure are specifically incorporated by reference herein in their entirety.

Where a range of numerical values is recited herein, unless otherwise stated, the range is intended to include the endpoints thereof, and all integers and fractions within the range. It is not intended that the scope of the various embodiments of the invention be limited to the specific values recited when defining a range. Moreover, all ranges set forth herein are intended to include not only the particular ranges specifically described, but also any combination of values therein, including the minimum and maximum values recited.

The embodiments of the present invention may be used in applications where the cationic modification of pigments is desired for the purpose of promoting a structured effect, for example an increased void volume, after drying. Thus the embodiments of the present invention are useful in industrial applications including, but not limited to, paper coatings, paper size press coatings, paper wet-end pigment retention, adhesives, drilling muds and the like.

The present invention generally relates to aqueous systems containing additive pre-mixes and processes for forming the same wherein the additive comprises a cationic polymer mixed with an anionic particle, methods of forming an aqueous system (e.g. aqueous paper coating color) containing the additive as well as a cellulose matrix coated therewith; and a process for preparing stabilized pre-mixes, wherein the anionic particle moderates the interaction of the cationic polymer with the anionic aqueous pigments and significantly reduces or eliminates pigment agglomeration.

As used herein, the term “system(s)” or derivations thereof shall include, but is not limited to, paper coatings, paint mixtures that contain a pigment, paper wet-end pigment retention, adhesives, drilling muds, paper size press coatings, and the like.

As used herein, the term “anionic particle” is meant to include both a high surface area, anionically charged inorganic mineral and/or a high surface area, anionically charged synthetic inorganic particle(s) and/or mixtures thereof.

As used herein, the term “indirect addition” is meant to describe mixing of cationic polymer and an anionic particle before either is added to an aqueous system, thereby forming a pre-mix.

As used herein, the term “direct addition” is meant to describe the addition of the cationic polymer to an aqueous system, such that no pre-mix is formed.

As used herein, the term “(co)polymer” is meant to include both homopolymers and copolymers.

The present invention relates to a pigmented aqueous system comprising:
(i) an additive pre-mix comprising a cationic polymer and an anionic particle (e.g. a high surface area, anionically charged inorganic mineral or synthetic particle).

The types of pigments for use in the aqueous system and the amounts of each that may be utilized vary widely, however, both of these aspects are well known to skilled artisans.

Pre-mix addition levels to the pigmented aqueous system range from 0.01-2.0 dry parts per 100 parts of pigment are preferred, 0.05 to 1.0 parts per 100 parts of pigment are more preferred, and 0.1 to 0.5 parts per 100 parts of pigment are most preferred. However, pre-mix addition levels will vary according to the charge density of the polymer.

Typically, the pre-mix has a solids content ranging from about 5% to about 40%, preferably 15% to about 30%, based on the total weight of the pre-mix.

Furthermore, in making the additive pre-mix the cationic polymer may be added into an anionic particle solution, wherein the cationic polymer may be quickly added, thereby resulting in a lower solids content solution. However, also contemplated is the addition of the anionic particles to the cationic polymer solution, which results in a high solids solution that may be diluted and stirred prior to use.

The cationic polymer for use in the present invention may be linear or branched and have some level of water solubility. Water soluble is meant to indicate that the cationic polymers are soluble or dispersible in a pigment pre-mix at an effective use concentration.

The cationic polymer may contain polar mer units, such as (meth)acrylamide, acrylonitrile and the like, or less polar nonionic mer units, such as lower alkyl esters of (meth)acrylic acid, for instance the C₁₋₄ alkyl esters of (meth)acrylic acid, provided such hydrophobic nature and density of such less polar mer units do not overly diminish the water solubility of the cationic polymer at use concentration.

Typical cationic polymers include those having a weight average molecular weight in a range from about 5,000 to about 3,000,000 daltons, preferably from about 10,000 to about 1,000,000 daltons, more preferably from about 20,000 to about 500,000 daltons.

Without being bound by theory, it is believed that the efficiency of the cationic polymer generally increases as the charge density increases. The cationic charge density of the cationic polymer of the present invention should preferably be relatively high. The cationic polymer preferably has a charge density ranging from about 0.1 meq/gram to about 8 meq/gram, and more preferably from about 1 meq/gram to about 8 meq/gram, and most preferably ranging from about 2.0 meq/gram to about 6.5 meq/gram. The charge density may be determined according to those conventional charge titration methods known within the art.

Suitable cationic polymers include those polymers used in water treatment or papermaking applications, including those described in U.S. Pat. Nos. 4,753,710; 5,246,548; 5,256,252; and 6,100,322, which are incorporated herein by reference. For example, representative cationic polymers described in U.S. Pat. No. 5,256,252 include (1) the quaternized salts of (co)polymers of N-alkylsubstituted aminoalkyl esters of (meth)acrylic acid including, for example, poly(diethylaminoethylacrylate) acetate, poly(diethylaminoethyl-methyl acrylate), poly(dimethylaminoethylmethacrylate) (“DMAEM.MCQ” as the methyl chloride quaternary salt) and the like; (2) the quaternized salts of reaction products of a polyamine and an acrylate type compound prepared, for example, from methyl acrylate and ethylenediamine; (3) (co)polymers of (methacryloyloxyethyl)trimethyl ammonium chloride; (4) (co)polymers of acrylamide and quaternary ammonium compounds such as acrylamide and diallylmethyl(beta-propionamido)ammonium chloride, acrylamide(beta-methacryloyloxyethyl)trimethylammonium methyl sulfate, and the like; (5) quaternized vinyllactam-acrylamide (co)polymers; (6) the quaternized salt of hydroxy-containing polyesters of unsaturated carboxylic acids such as poly-2-hydroxy-3-(methacryloxy)propyltrimethylammonium chloride; (7) the quaternary ammonium salt of polyimide-amines prepared as the reaction product of styrene-maleic anhydride (co)polymer and 3-dimethylaminopropylamine; (8) quaternized polyamines; (9) the quaternized reaction products of amines and polyesters; (10) the quaternized salt of condensation (co)polymers of polyethyleneamines with dichloroethane; (11) the quaternized condensation products of polyalkylene-polyamines and epoxy halides; (12) the quaternized condensation products of alkylene-polyamines and polyfunctional halohydrins, such as epichlorohydrin/dimethyl amine (co)polymers (“EPI-DMA”); (13) the quaternized condensation products of alkylene-polyamines and halohydrins; (14) the quaternized condensation (co)polymers of ammonia and halohydrins; (15) the quaternized salt of polyvinylbenzyltrialkylamines such as, for example, polyvinylbenzyltrimethylammonium chloride; (16) quaternized salt of (co)polymers of vinyl-heterocyclic monomers having a ring nitrogen, such as poly(1,2-dimethyl-5-vinylpyridinium methyl sulfate), poly(2-vinyl-2-imidazolinium chloride) and the like; (17) polydialkyldiallylammonium salt including polydiallyldimethyl ammonium chloride (“polyDADMAC”); (18) (co)polymers of vinyl unsaturated acids, esters and amides thereof and diallyidialkylammonium salts including poly(acrylic acid-diallyldimethylammonium chloride-hydroxypropylacrylate) (“polyAA-DADMAC-HPA”); (19) polymethacrylamidopropyltrimethylammonium chloride (“polyMAPTAC”); (20) the quaternary ammonium salt of ammonia-ethylene dichloride condensation (co)polymers; and (21) the quaternized salt of epoxy halide (co)polymers, such as the polyepichlorohydrin methyl chloride, polyepichlorohydrin methyl sulfate and the like. Mixtures comprising two or more of the above-identified polymers may also be utilized.

Preferred cationic polymers include (co)polymers of diallyldialkylammonium salts, (co)polymers of diallylamine, (co)polymers of diallylamine, polyethylene imine, (co)polymers of dialkylamine/epichlorohydrin, (co)polymers of polyamine/epichlorohydrin, (co)polymers of polyamide/epichlorohydrin, (co)polymers of polyamideamine, (co)polymers of polyamideamine/epichlorohydrin, (co)polymers and quaternized (co)polymers of dialkylaminoalkyl acrylamide and methacrylamide, and (co)polymers and quaternized (co)polymers of dialkylaminoalkyl acrylate and methacrylate esters. More preferred cationic polymers include (co)polymers of diallyldimethylammonium salts, (co)polymers of polyamine/epichlorohydrin, polyethylene imine, (co)polymers of dimethylamine/epichlorohydrin, and polyamideamine/epichlorohydrin (co)polymers. The most preferred cationic polymers include (co)polymers of diallyldimethylammonium salts and (co)polymers of dimethylamine/epichlorohydrin. Mixtures comprising two or more of the above-identified polymers may also be utilized.

It is preferred that the cationic polymer concentration in the pre-mix is less than 2.5% when it is added to the aqueous system, more preferably 1.5% or less, most preferably 1.0% or less.

Generally, the cationic polymers may be made according to any conventional method known within the art.

Generally, as noted above, the anionic particle for use in the present invention comprises a high surface area, anionically charged inorganic mineral and/or high surface area anionically charged synthetic inorganic particle and/or mixtures thereof.

Examples of suitable anionically charged inorganic minerals and synthetic inorganic particles of the present invention generally include swelling clays such as, for example, the smectite clays, as well as silica-based particles (e.g. silica and alumino-silicate based particles).

The smectite clays that can be used are well known in the paper retention aid art and include the swellable clays and synthetic or semi-synthetic equivalents thereof.

Suitable smectite clays include, but are not limited to, those described in U.S. Pat. No. 4,753,710 which is incorporated herein by reference in its entirety, as well as including for example, members of the dioctahedral smectite group (e.g. montmorillonite, bentonite, montmorillinite, beidelite, and nontronite) and members of the trioctahedral group (e.g. hectorite and saponite), sepolite, sepialite and attapulgite.

Suitable bentonites and hectorites are disclosed in U.S. Pat. Nos. 4,305,781; 4,753,710; 5,501,774; 5,876,563; EP 0235893 which is also published as U.S. Pat. No. 4,753,710 (e.g. the bentonite can be anionic swelling clays such as sepialite, attapulgite, or preferably montmorillinite. Bentonites broadly described in U.S. Pat. No. 4,305,781 are suitable. Suitable montmorillonite include Wyoming bentonite or Fuller's earth. The clays may or may not be chemically modified, e.g. by alkali treatment to convert calcium bentonite to alkali metal bentonite.); and EP 0446205 which is also published as U.S. Pat. No. 5,071,512, respectively, which are incorporated herein by reference.

It is preferred that the swelling clays are colloidal, i.e. having a particle size in the range of about 1 millimicron (1 nanometer) to about 1 micron (1 micrometer). Moreover the swelling clays preferably have a surface area of at least 50 m²/g, more preferably a surface area of at least 100 m²/g, and most preferably a surface area of at least 200 m²/g. For example, the surface area of the bentonite after swelling is preferably at least 400 m²/g. Typical coating clays and calcium carbonates have surface areas of 1-12 m²/g.

Preferably the swelling clays, most preferably bentonite, have a dry particle size of at least 60% below 50 microns (dry size), more preferably at least 90% below 100 microns, and most preferably at least 98% below 100 microns.

The silica-based particles that can be used according to the present invention include those described in U.S. Pat. Nos. 5,167,766 and 5,274,055, for example, colloidal silica, colloidal aluminum-modified silica or aluminum silicate (compounds of this type are also referred to as polyaluminosilicates and polyaluminosilicate microgels, which are both encompassed by the terms colloidal aluminum-modified silica and aluminum silicate used herein), and mixtures thereof, either alone or in combination with other types of anionic inorganic particles and the like that are used as retention aids as is well known in the art. Further suitable silica and alumino-silicate based particles include those disclosed in U.S. Pat. Nos. 4,388,150; 4,954,220; 4,961,825; 4,927,498; 4,980,025; 5,127,994; 5,176,891; 5,368,833; 5,447,604; 5,470,435; 6,100,322; EP 0656872 which is also published as U.S. Pat. No. 5,603,805, and WO 95/23021 which are all hereby incorporated herein by reference.

Suitable silica-based particles have a particle size preferably below about 50 nanometers, more preferably below about 20 nanometers and most preferably in the range of from about 1 to about 10 nanometers. The suitable silica-based particles have a specific surface area of at least 50 m² /g, preferably at least 100 m²/g, and preferably at least 200 m²/g. The specific surface area can be measured by means of titration with NaOH according to the method described by Sears in Analytical Chemistry 28(1956):12, 1981-1983.

Mixtures of silica and swelling clays (e.g. smectite clays, preferably natural sodium bentonite) may also be used in the present invention.

In general the ratio of anionic particle to the cationic polymer in the additive pre-mix may range from about 95:5 to about 10:80 (about 95 wt-% to about 10 wt-% of the anionic particle and about 5 wt-% to about 80 wt-% of the cationic polymer), preferably about 90:10 to about 20:80 (about 90 wt-% to about 20 wt-% anionic particle and about 10 wt-% to about 80 wt-% of the cationic polymer), more preferably 90:10 to about 40:60 (about 90 wt-% to about 40 wt-% of the anionic particle and about 10 wt-% to about 60 wt-% of the cationic polymer), most preferably 85:15 to about 60:40 (about 85 wt-% to about 60 wt-% of the anionic particle and about 15 wt-% to about 40 wt-% of the cationic polymer). However, the ratio is dependent upon the polymer that is used, for example when using a mixture of bentonite and poly-DADMAC, the ratio of bentonite:poly-DADMAC preferably ranges from about 92.5:7.5 to 60:40 and more preferably ranging from about 70:30 to about 85:15.

The present invention further relates to forming an aqueous system (e.g. aqueous paper coating color) comprising:
(1) mixing the anionic particle and the cationic polymer; wherein an additive pre-mix is formed,
(2) optionally filtering the additive pre-mix;
(3) optionally adding a stabilizing agent to the additive pre-mix;
(4) optionally adding the additive pre-mix to a coating starch;
(5) optionally adding a biocide to the additive pre-mix; and
(6) adding the additive pre-mix to an aqueous system.

Still further, the present invention includes coating a cellulose matrix in accordance with the process described above, as well as the coated cellulose matrix, further including the steps of
(7) coating a cellulose matrix; and
(8) drying the cellulose matrix (e.g. paper).

The additive pre-mix may be added to the aqueous system at any point during the preparation of the coating. Preferably, however, the pre-mix is added to the coating starch or is added last. The coating starch is a component of many coating formulations, wherein the pre-mix is added to the coating starch in order to dilute the pre-mix. The coating starch typically contains a high percentage of water (e.g. about 70% water versus the solids content), thereby allowing for the dilution of the pre-mix without introducing further amount of water to the overall aqueous system. However, in each case, the additive pre-mix is added indirectly, wherein as shown above the additive pre-mix is formed prior to being added to an aqueous system. Those anionic particles and cationic polymers described above may be used herein.

In general, the order of mixing in step (1) is not critical to the performance when a non-swelling anionic particle is used, but typically, the anionic particle is added “as is” to the polymer solution. Although, when high solids pre-mixes (>5% solids) are being produced, the order of the steps in the process is important. If a swelling clay (e.g. bentonite or the like) is used, it is preferred that the anionic particle be added to an amount of water containing the cationic polymer versus adding the swelling clay to water and then adding the polymer.

The pre-mix may be optionally filtered to remove any grit formed, as shown in step (2), using those methods known in the art such as, for example using a Ronningen-Petter DCF-800 filter with a 100 micron slotted screen, where the filter automatically wipes the screen to prevent blinding of the screen.

The optional stabilizing agent that may be added to the pre-mix in step (3) is included to reduce any settling or stratification of the anionic particles in the pre-mix. The stabilizing agent may have either a high molecular weight or medium molecular weight and may be either cationic or nonionic. Nonionic stabilizing agents include hydroxymethylhydroxyethyl cellulose, butylglycidylether modified hydroxyethyl cellulose, hydroxypropyl cellulose, methylhydroxyethylcellulose, methylhydroxypropyl cellulose, methyl cellulose, ethyl cellulose, poly-N-vinylpyrolidone, polyvinyl alcohol, polyethylene oxide, polypropylene oxide, polyacrylamide, starch ethers (e.g. hydroxy ethyl starch), starch esters (e.g. alkyl succinic anhydride modified starch), oxidized starch, guar, pectin, carrageenan, locust bean gum, xanthan gum, water soluble proteins (e.g. soy) and hydrophobically associative paint thickeners. Cationic stabilizing agents comprise cationic starch and Galactosol cationic guar (Hercules Inc., Wilmington Del.). Preferably the stabilizing agent is nonionic. Most preferably the stabilizing agent is hydroxypropyl guar or hydroxyethyl cellulose.

Generally, the stabilizing agent is utilized in amounts resulting in the viscosity of the aqueous system being at least 1000 cps (Brookfield viscosity at 100 RPM), preferably a viscosity of at least 2000 cps, more preferably at least 3000 cps. Most preferably the viscosity is in the range of about 2000 to about 3500 cps.

Typically the stabilizing agent is added in amounts ranging from about 0.1% to about 5%, based on the total weight of the pre-mix, however such amount are dependent upon the type of stabilizer and the pre-mix solids content. For example, with respect to hydroxyethyl cellulose and hydroxypropyl guar the preferred amounts range from about 0.2% to about 1.0%, more preferably 0.3% to about 0.7%, based on the total weight of the pre-mix. Addition rates and stirring of the stabilizing agent are well known in the art and should be adjusted to obtain a smooth mixture.

The optional biocide of step (5) is typically used when it is desired to prevent bacteria from consuming particular polymers such as, for example guar, which results in odors, stratification and a lack of storage stability. The aqueous system could be prepared without the use of the biocide however, refrigeration, vacuum packing, or use within a short time period is typically required because of the negative effects of bacteria. Examples of suitable biocides include, for example AMA-35D-P biocide (Kemira Chemical Co. Marietta, Ga.) and Proxel GXL (Avecia Inc., Wilmington Del.

With respect to step (6), the pre-mix is typically pumped or poured into the aqueous system without any particular restrictions on its method or rate of addition. As noted above, it is preferred that the cationic polymer concentration in the pre-mix is less than 2.5% when it is added to the aqueous system, more preferably 1.5% or less, most preferably 1.0% or less.

The cellulose matrix can be coated according to those methods known in the art such as, for example, as described in Lehtinen, Esa; Pigment Coating and Surface Sizing of Paper, pages 415-594, Published by Fapet Oy (2000).

The drying of the cellulose matrix can be performed according to those methods known within the art, such as, for example, as described in Lehtinen, Esa; Pigment Coating and Surface Sizing of Paper, pages 415-594, Published by Fapet Oy (2000).

The present invention further relates to a process for preparing stable pre-mixes of polymers and anionic particles suitable for later use after periods of storage. More specifically, the process for preparing stabilized anionic particle/polymer pre-mixes, as well as the stabilizing agent, comprising:
(a) forming a pre-mix comprising an anionic particle, preferably bentonite,and a cationic polymer;
(b) adding a stabilizing agent (neutral or cationic) to the pre-mix; wherein a stable pre-mix is formed; and
(c) optionally adding a biocide to the pre-mix.

Examples of suitable bentonites include in addition to those described above, for example, commercially available compositions such as sodium bentonite (Wyoming or Western), which has a high swelling capacity in water.

The cationic polymer component of the present invention may be any cationic polymer used in conventional papermaking processes such as those described above. Similarly, the anionic particle and stabilizing agent described above may also be used herein.

Generally, as noted above, the stabilizing agent is utilized in amounts resulting in the viscosity being at least 1000 cps (Brookfield viscosity at 100 rpm), preferably a viscosity of at least 2000 cps, more preferably at least 3000 cps. Most preferably, the viscosity is in the range of about 2000 to about 3500 cps. In addition, the stabilizing agent is typically added in amounts ranging from about 0.2% to about 5%, based on the total weight of the pre-mix, however such amounts are dependent upon the type of stabilizer and the pre-mix solids content. For example, with respect to hydroxyethyl cellulose and hydroxypropyl guar the preferred amounts range from about 0.2% to about 1.0%, more preferably 0.3% to about 0.7%, based on the total weight of the pre-mix.

The present invention further relates to the stabilized pre-mix resulting from the above-described process.

### EXAMPLES

The present invention is further defined in the following Examples, in which all parts and percentages are by weight. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usage and conditions.

### Example 1

### Preparation of an 85:15 Bentonite:Poly-DADMAC Pre-mix

A 5% solids 85:15 bentonite:poly-DADMAC cationic polymer pre-mix was made using the following method. 106.25 g of bentonite (Bentolite H from Southern Clay Products, Gonzalez, Tex.) and 2346.88 g of water were loaded into a 5-L beaker, then mixed using an over-head stirrer for 1-2 minutes until a uniform pre-mix was obtained (500 rpm). 46.88 g of PRP-4440 poly-DADMAC (diallyldimethylammonium chloride polymer, 40% solids, available from Pearl River Polymers, Riceboro, Ga.) was then added drop-wise over a 1-2 minute period with stirring. The mixture swelled and thickened, the re-dispersed during the poly-DADMAC addition. Once the addition was complete, the pre-mix was stirred for an additional two hours, sonicated for 10 minutes at setting #2 on a Branson Sonifier 450, and then filtered through a 200-mesh screen to remove any grit. If necessary, the pH of the finished pre-mix was adjusted to pH 7-8 using 15% H₂SO₄.

### Example 2

### Preparation of Silica:Reten 203 Pre-mixes

5% solids silica:Reten 203 cationic polymer pre-mixes were made over the range of ratios shown in Table 1 using the following method. The desired amounts of silica (Ludox FM, Grace-Davison, Columbia, Md.) and water were loaded into a 100 mL beaker, then mixed for 15 minutes using an over-head stirrer (500 rpm). The required amount of Reten 203 (diallyldimethylammonium chloride polymer, Mₙ=2-300,000, 20% solids, available from Hercules Incorporated, Wilmington, Del.) was then added dropwise with vigorous stirring (formation of a good vortex). The pre-mixes were then stirred for 2.5 hours, and sonicated for 3 minutes at setting #8 on a Branson Sonifier 450. The dipsersions were then filtered through a 200 mesh screen to remove any grit. If necessary, the pre-mixes were adjusted to pH 7-8 with 15% H₂SO₄.

TABLE 1

| | | | |
|---|---|---|---|
| Final % Total Solids: | 5 | % TS of Silica Soln: | 16.02 |
| Final pH: | 7-8 | % TS of Reten Soln: | 20.41 |
| Final Volume: | 25 | | |

| Ratio | | | | | | |
|---|---|---|---|---|---|---|
| Silica | Reten | % Silica | g. silica | % Reten | g. Reten | g. water |
| 100 | 1 | 4.95 | 7.73 | 0.05 | 0.06 | 17.21 |
| 100 | 10 | 4.55 | 7.09 | 0.45 | 0.56 | 17.35 |
| 100 | 50 | 3.33 | 5.20 | 1.67 | 2.04 | 17.76 |
| 100 | 100 | 2.50 | 3.90 | 2.50 | 3.06 | 18.04 |
| 50 | 100 | 1.67 | 2.60 | 3.33 | 4.08 | 18.32 |
| 10 | 100 | 0.45 | 0.71 | 4.55 | 5.57 | 18.72 |
| 1 | 100 | 0.05 | 0.08 | 4.95 | 6.06 | 18.86 |

### Example 3

### Preparation of Kaolin Clay/Calcium Carbonate Coating Color

A kaolin clay/calcium carbonate based coating color was made using the following method. A detailed description of the formulation is given in Table 2. The required amounts of dilution water and dispersant (Dispex N40V, Ciba Specialty Chemicals, Sufolk Va.) were added first. The Hydrafine® #1 kaolin clay (available from the J. M. Huber Corporation, Edison, N.J.) was then added slowly with vigorous stirring using a Cowles mixer. A good vortex was maintained throughout the clay addition. Once the clay was well dispersed, the Hydrocarb® 90 ground calcium carbonate (Omya, available from Pleuss-Staufer Incorporated, VT) and RPS TiO₂ slurry (available from E.I. duPont de Nemours and Company, Wilmington, Del.) were added slowly and with vigorous mixing. The slurry was then stirred for an additional 30 minutes using a Cowles mixer.

While the pigment slurry was being made, the Penford 290 starch (available from Penford Products Co. Cedar Rapids, Iowa) was cooked at 95-100° C. for 45 minutes using a steam jacketed kettle. Starch concentration (30%) was adjusted to compensate for water loss during cooking. The hot starch solution (stored at 65° C.) was then added to the pigment slip with vigorous stirring. After the coating had cooled from the starch addition, the styrene butadiene latex (Dow 620, Latex CP620NA, Dow U.S.A. Midland, Mich.) was added and thoroughly mixed into the coating color. Calsan® 65 lubricant (BASF, North Mount Olive, N.J.), Sequarez® 755 insolublizer (Omnova Solutions Corporation, Fairlawn, Ohio), and the Proxel GXL preservative (Avecia Inc.) were added sequentially with vigorous mixing. Once the additives were well dispersed, the pH of the coating color was adjusted to 8.0 with ammonium hydroxide. The coating color solids were adjusted to 68% with water prior to particle/cationic polymer mixture addition.

The bentonite/poly-DADMAC (Example 1), and silica/poly-DADMAC (Example 2) pre-mixes were added to the clay/carbonate coating color using the following method. The required amount of particle/cationic polymer pre-mix was added dropwise to a well-stirred sample of the coating color (68% solids). The bentonite and silica pre-mixes were added at 5% total solids unless otherwise noted. A good vortex was maintained throughout the addition of the particle pre-mix. The required amount of water was then added to dilute the coating color to 62% total solids, unless otherwise noted. The treated sample was stirred for an additional 15-30 minutes prior to testing (500 rpm).

TABLE 2
Clay/Carbonate Formulation

| | | | dry | | wet grams |
|---|---|---|---|---|---|
| Additive | Description | parts | grams | % solids | added |
| #1 Kaolin | Hydrafine | 58 | 1740 | 100% | 1740 |
| GCC | Hydrocarb 90 | 41 | 1230 | 100% | 1230 |
| TiO2 | RPS Slurry | 1 | 30 | 71% | 42.3 |
| Latex | Dow 620 | 9 | 270 | 50% | 540 |
| Starch | Penford 290 | 3 | 90 | 30.36% | 296.4 |
| Lubricant | Calsan 65 | 0.3 | 9 | 50% | 18 |
| Dispersant | Disperx N-40 | 0.1 | 3 | 40% | 7.50 |
| Insolubilizer | Sequarez 755 | 0.21 | 6.3 | 55% | 11 |
| Preservative | Proxel GXL | 0.1 | 3 | 100% | 3 |
| Base | Ammonium | as | | | |
| | Hydroxide | needed | | | |

| | |
|---|---|
| Total Dry Grams | 3378.3 |
| Total Wet Grams | 3885.65 |
| Final Solids | 68% |
| Grams Added to Water | 1082.44 |
| Final Total Weight | 4968.09 |

### Example 4

### Bentonite/Poly-DADMAC Pre-mix

663 g of water and 108.4 g of PRP-4440 poly-DADMAC (diallyldimethylammonium chloride polymer, 40% solids, Pearl River Polymers, Riceboro, Ga.) were loaded into a stainless steel beaker and stirred for five minutes at 500 rpm. 228.3 g of bentonite (as received, 92.7% solids, Bentolite H from Southern Clay Products, Gonzalez, Tex.) was then mixed in over a five minute period. After the addition was complete, the pre-mix was stirred at 500 rpm for two hours. The temperature of the pre-mix was maintained at 20° C. throughout the process. The pre-mix was then filtered through a 200-mesh screen to remove any grit formed by aggregation of the anionic bentonite clay and the cationic polymer. Approximately 0.5 g of grit was isolated on the screen (0.2% of total solids).

Once the filtration was complete, 1.2 g of biocide (AMA-35D-P biocide, Kemira Chemical Co. Marietta, Ga.) and then 6.0 g of hydroxypropyl guar (HPG, Galactasol 40H4FD1—Hercules, Wilmington, Del.) were sprinkled into the pre-mix with continued mixing. The pre-mix was stirred for an additional three hours after the additions were complete (500 rpm). The temperature of the pre-mix was maintained at 20° C. throughout the process. The viscosity of the pre-mix increased rapidly for the first 30-60 minutes after the hydroxypropyl guar addition. The final product had a pH of 7.9 and a Brookfield RV viscosity of 3000 cps (100 rpm, spindle #5).

### Example 5

### Effect of Pre-mix solids and HPG Addition Level on Stratification

A screening experiment was carried out to determine the highest bentonite/poly-DADMAC pre-mix solids that can be made using the addition sequence described in Example 4. As shown in Table 3, fluid pre-mixes were made with total solids as high as 40%. Pre-mix Brookfield RV viscosity increased as % solids increased (100 rpm).

TABLE 3

| % Solids | Brookfield Viscosity |
|---|---|
| 21% | 34 cps |
| 24% | 42 cps |
| 27% | 50 cps |
| 30% | 64 cps |
| 35% | 120 cps |
| 40% | 260 cps |

The effect of HPG on settling stability was then measured at 21%, 24% 27%, and 30% pre-mix solids. The method described in Example 4 was used to make the pre-mixes. The HPG addition levels were selected to give pre-mix viscosities ranging from 500 cps to 3500 cps at each % solids. Acceptable settling stability was defined as less than 5% solids stratification from the top to the bottom of the pre-mix with no hard-pack formation.

As shown in Table 4, pre-mix stability generally increased as % solids, HPG addition level, and pre-mix viscosity increased. All 16 pre-mixes gave good 1-day settling stability. All of the pre-mixes with an initial viscosity of at least 1500 cps (Brookfield RV, 100 rpm) gave at least one week of acceptable storage stability. All of the pre-mixes with an initial viscosity less than 1500 cps failed the stability test after one week of storage. All of the pre-mixes with an initial viscosity of at least 2200 cps gave at least four weeks of acceptable storage stability. And, all of the pre-mixes with an initial viscosity of at least 3000 cps showed no signs of stratification or hard pack formation after eight weeks of storage. Testing of the pre-mixes that passed the four-week and eight-week stability tests showed that they gave the expected increase in coating viscosity without pigment shock when tested in the coating formulation described in Example 3. The pre-mixes were diluted to 5% total solids and stirred for 30 minutes before addition to the coating. The amount of grit retained on a 200-mesh screen from a 200 g sample of treated coating was used as a measure of pigment shock.

### Example 6

### Preparation of a Stable Bentonite/Poly-DADMAC Pre-mix

255 grams of bentonite (Bentonite H, available from Southern Clay Products) and 1632.5 grams of water were loaded into a stainless steel beaker, then mixed for 1-2 minutes using an over-head stirrer (500 rpm). 112.5 grams of PRP-4440 poly-DADMAC (diallyldimethylammonium chloride polymer, 40% solids, available from Pearl River Polymers, Riceboro, Ga.) was added dropwise with vigorous stirring over a 1-2 minute period. The mixture swelled and thickened, then re-dispersed to a fluid pre-mix during the PRP-4440 addition. Once the addition was complete, the mixture was stirred for an additional 90 minutes, then sonicated for 15 minutes at setting #2 on a Branson Sonifier 450.

A 200 mL aliquot of the cationic bentonite pre-mix was then loaded into a glass beaker. 1.0 gram of Natrosol 250 H4BR (Hydroxyethyl cellulose, available from Hercules, Wilmington, Del.) was added slowly to the pre-mix with vigorous mixing using an over-head stirrer. Once the addition was complete, the mixture was stirred for an additional 30 minutes, then sonicated for 6 minutes at setting #2 using a Branson Sonifier 450. After two weeks at room temperature, no signs of pre-mix settling or stratification were observed.

### Example 7

### Effect of Pre-mix Dilution on Pigment Shock

The degree of pigment shock caused by direct addition of PC-1193 (equivalent to PRP-4440 from Pearl River Polymers, diallyldimethylammonium chloride polymer, hereafter referred to as PRP-4440) was measured at solution concentrations of 0.75% and 2.25%. These solution concentrations correspond to the concentrations of PRP-4440 in 5% and 15% total solids 85:15 bentonite:PRP-4440 pre-mixes, respectively. The bentonite pre-mixes were made using the method described in Example 6. The evaluation was carried out in the clay/carbonate coating color described in Example 3. The amount of grit retained on a 200 mesh screen from a 200 g sample of treated coating was used as a measure of pigment shock.

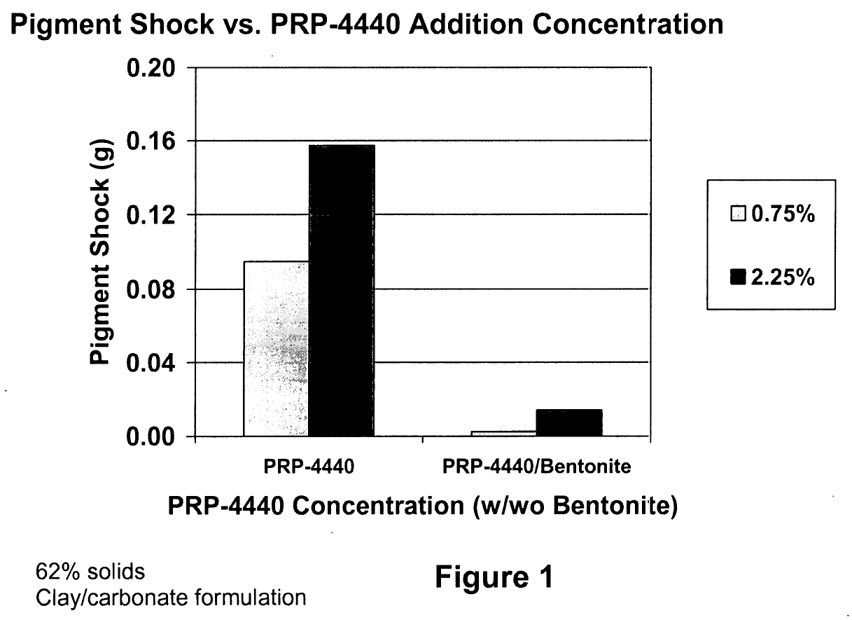

As shown in FIG. 1, decreasing the solution concentration of PRP-4440 from 2.25% to 0.75% significantly reduced the degree of pigment shock in the clay/carbonate coating color. Reducing the concentration of the 85:15 bentonite:PRP-4440 mixture from 15% (2.25% PRP-4440) to 5% (0.75% PRP-4440) total solids also reduced pigment shock. A comparison of the degree of pigment shock caused by direct addition of PRP-4440 at 2.25% solids and addition of the 85:15 bentonite mixture at 15% total solids (also 2.25% PRP-4440) showed that pre-mixing the PRP-4440 with bentonite reduced pigment shock by 85-90%. A similar comparison at a PRP-4440 solution concentration of 0.75% and a bentonite mixture concentration of 5% total solids (also 0.75% PRP-4440) showed that pre-mixing (indirect addition) the PRP-4440 with bentonite reduced pigment shock by 98-99%. The 5% solids 85:15 bentonite mixture gave pigment shock comparable to an untreated coating control.

### Example 8

### Effect of Bentonite/Poly-DADMAC Dilution on Coating Viscosity

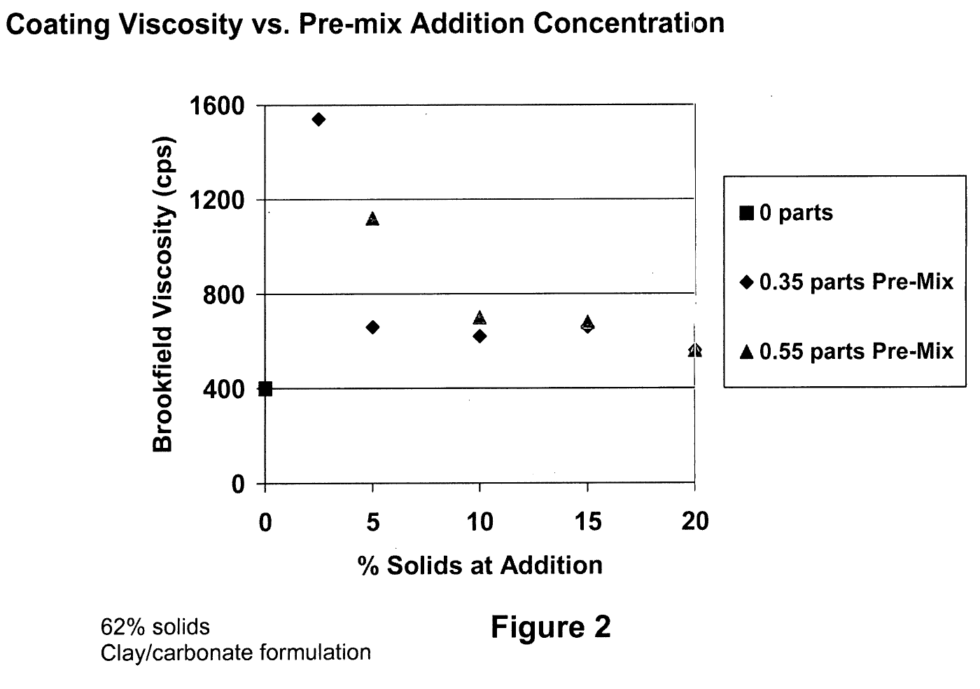

85:15 bentonite:PRP-4440 pre-mixes were made at total solids concentrations ranging from 2.5% to 20% by dilution of a 25% solids pre-mix made using the method described in Example 4. Each pre-mix was then tested for its effect on the Brookfield viscosity of the kaolin clay/calcium carbonate coating formulation described in Example 3. Pre-mix addition levels ranging from 0.35 to 0.55 parts based on coating pigment were tested. At a given pre-mix addition level, coating Brookfield viscosity (Brookfield LVT, 60 r.p.m.) increased as the addition concentration of the pre-mix decreased (See FIG. 2).

### Example 9

### Effect of Poly-DADMAC/Bentonite Ratio

Bentonite/poly-DADMAC pre-mixes were made using high (Mₙ=2-300,000, Reten 203, Hercules, Wilmington, Del.) and low (Mₙ=30,000, PRP-4440, Pearl River Polymers, Riceboro, Ga.) molecular weight diallyldimethylammonium chloride polymers (poly-DADMAC). A high surface area bentonite clay (Bentolite H, Southern Clay Products) was used as the anionic particle of the pre-mixes. The cationic polymer content of the pre-mixes was varied from 5 to 50% of the total solids (See Tables 5 and 6, 95%-50% bentonite). The pre-mixes were made using the method described in Example 1.

Each of the bentonite/poly-DADMAC pre-mixes was then tested for its effect on Brookfield viscosity and pigment shock in the kaolin clay/ground calcium carbonate based coating described in Example 3. The addition concentration of the cationic polymer can have a significant effect on its performance (Examples 7 and 8). Therefore, each pre-mix addition concentration was selected to give the same cationic polymer addition concentration (0.75%) over the entire range of bentonite/poly-DADMAC ratios. As shown in Tables 5 and 6, the % total solids of each pre-mix, and therefore its addition concentration, varied with the ratio of poly-DADMAC to bentonite. In general, the increase in coating viscosity obtained at a given cationic polymer addition level increased as the percentage of cationic polymer in the pre-mix increased. Therefore, the addition level of each pre-mix was adjusted to give the same coating viscosity (approximately 2000 cps, Brookfield RV, 100 rpm, spindle #4 or #5). An untreated coating (the coating itself) was tested as a control. Direct additions of the high and low molecular weight poly-DADMAC cationic polymers were also tested in an effort to quantify the benefits of pre-forming the pre-mixes. The solution concentration of the cationic polymers was fixed at 0.75% solids, the same addition concentration as the cationic polymers in the bentonite/poly-DADMAC pre-mixes.

Each of the treated coatings (coatings containing the additive pre-mix) was then checked for pigment shock. As described in Example 7, the amount of grit retained on a 200 mesh screen from a 200 g sample of the coating was used as a measure of pigment shock. The results are shown in Tables 5 and 6. Direct addition of either of the cationic poly-DADMAC polymers gave significant pigment shock. For both the high and low molecular weight poly-DADMAC's, the pre-mixes made at poly-DADMAC concentrations between 15% and 30% (85%-70% bentonite) gave the best results. Pre-mixes made over this range of poly-DADMAC addition levels gave large increases in coating viscosity with much less pigment shock than direct addition of the corresponding cationic polymer. Lower and higher concentrations of poly-DADMAC in the bentonite pre-mix gave reduced levels of performance. The pre-mixes made at poly-DADMAC addition levels between 7.5% and 15%, and at the 40% poly-DADMAC addition level, gave large increases in coating viscosity with intermediate levels of pigment shock. The pre-mixes made at the 5% and 50% poly-DADMAC addition levels gave pigment shock comparable to direct addition of the corresponding poly-DADMAC cationic polymer.

Based on these results, bentonite/poly-DADMAC pre-mixes containing between 7.5% and 40% poly-DADMAC (92.5%- 60% bentonite) are preferred. Pre-mixes containing 15%-30% poly-DADMAC (85%-70% bentonite) are more preferred.

### Example 10

### Pilot Coater Evaluation in Kaolin Clay/Calcium Carbonate Coating

An 85:15 bentonite:PRP-4440 pre-mix was evaluated for coating performance on a cylindrical lab coater (CLC) at Western Michigan University. The pre-mix was made at 5% total solids using the method described in Example 1. The clay/carbonate coating color and addition methods described in Example 3 were used. The pre-mix addition concentration was fixed at 5% total solids. An uncoated groundwood base sheet was used as the substrate (38 g/m²). Coating speed was fixed at 925 meters/minute. The bentonite/PRP-4440 pre-mix was evaluated at 0.45 parts and 0.65 parts addition levels. An untreated coating was tested as a control. The gap spacing between the base sheet and the coating blade was adjusted to give coat weights ranging from 3-8 g/m² per side for the control and bentonite:PRP-4440 treated coatings The coated paper was calendered three times at 65° C. and 1000 pounds per linear inch prior to testing.

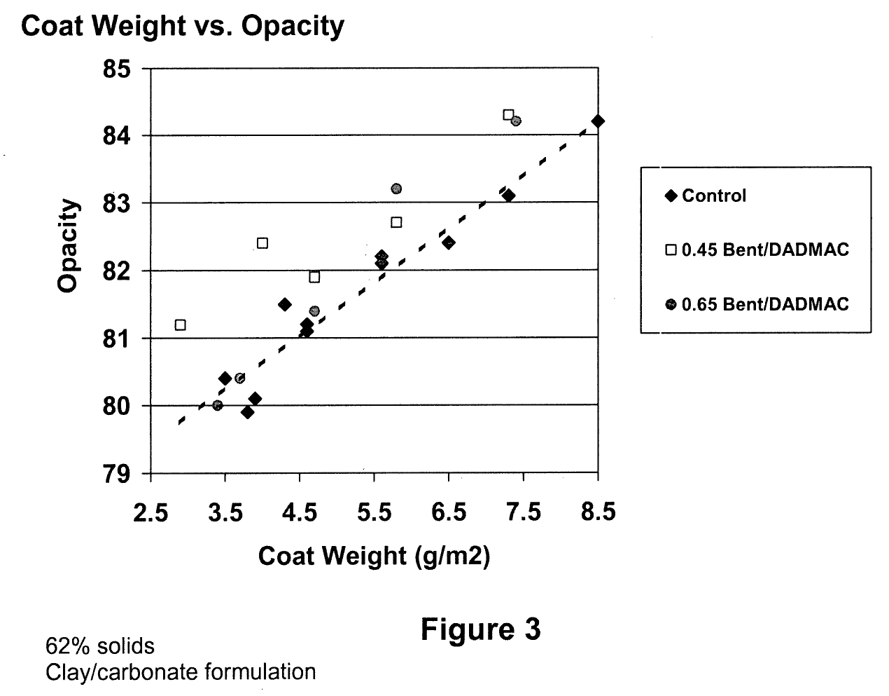

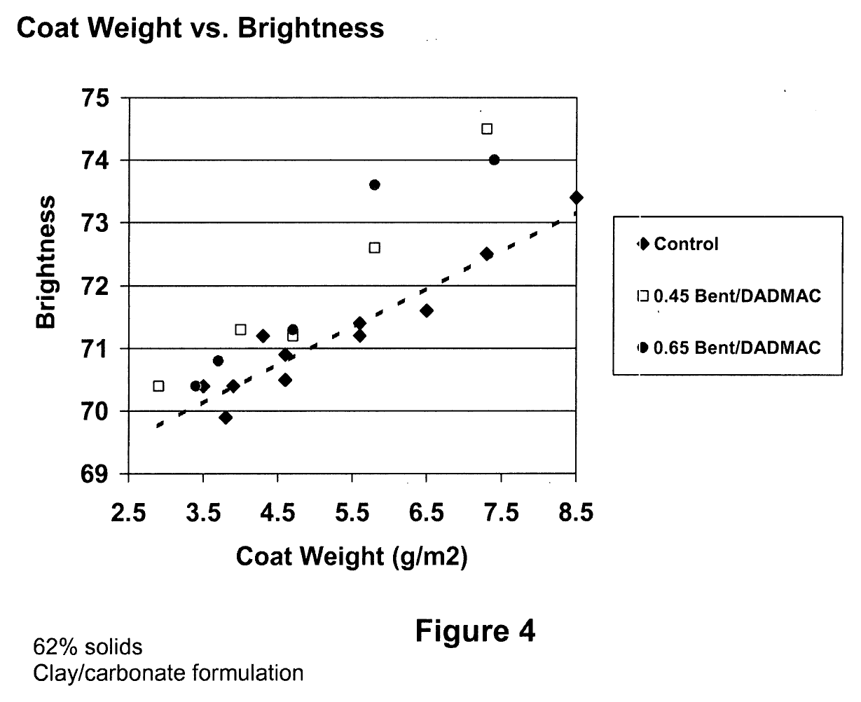

The results of opacity and brightness testing of the CLC coated paper are shown in FIGS. 3 and 4. When compared over the entire range of coat weights, the bentonite:PRP-4440 treated coatings had significantly higher opacity and brightness than the untreated control.

### Example 11

### Effect of Bentonite/Poly-DADMAC Addition Concentration

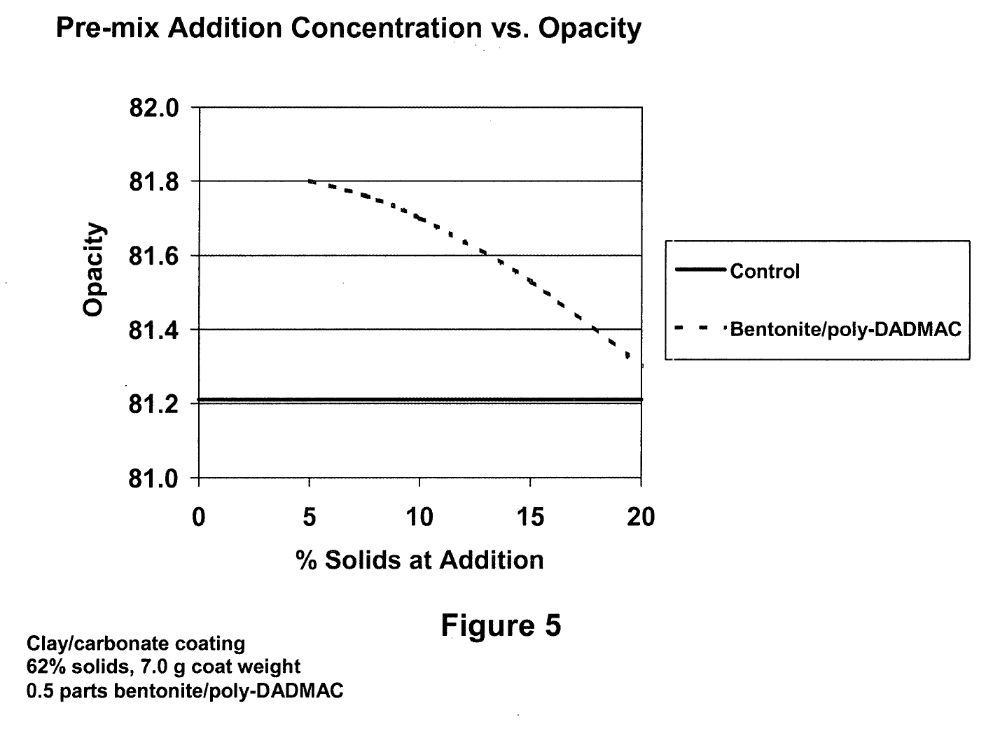

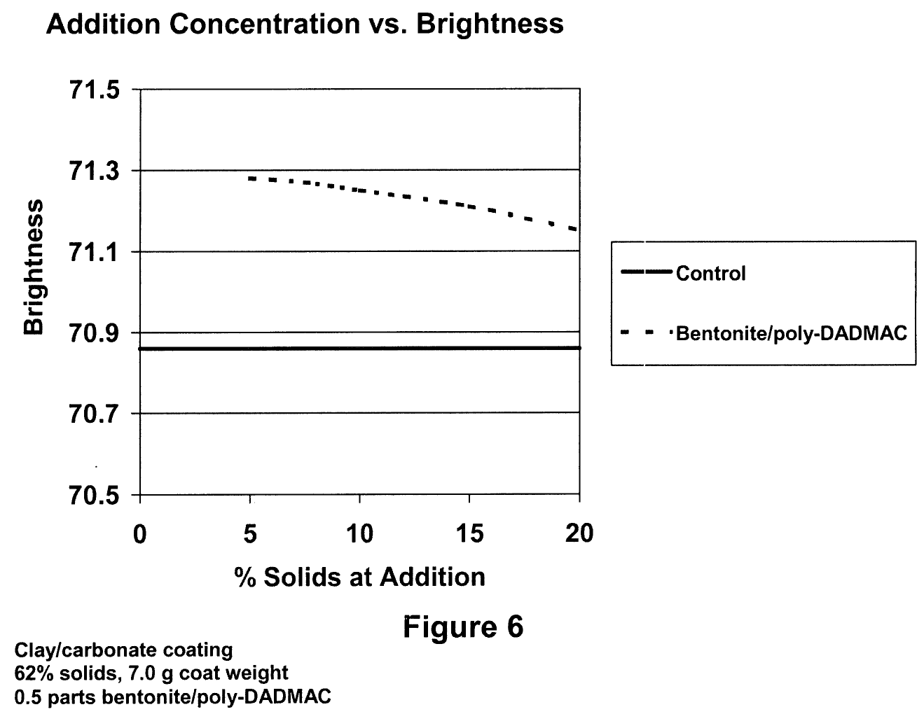

Bentonite/poly-DADMAC pre-mixes were made at total solids concentrations ranging from 2.5% to 20% by dilution of a 25% solids pre-mix made using the method described in Example 4. Each pre-mix was then tested for its effect on coating opacity and brightness. The study was carried out on the Western Michigan University cylindrical lab coater (CLC) using the 62% solids clay/carbonate coating formulation described in Example 3 and the methods described in Examples 10. As shown in FIGS. 5 and 6 (best regression fits of data), the increases in opacity and brightness obtained by adding 0.5 parts of the bentonite/poly-DADMAC pre-mix dropped steadily as the addition concentration increased. Without wishing to be bound by theory, these results suggest that the increases in brightness and opacity obtained with the bentonite/poly-DADMAC pre-mix were related to the observed increases in Brookfield viscosity. Based on these results, addition concentrations as high as 10% total solids are preferred. Pre-mix addition concentrations less than 8% total solids are more preferred.

### Example 12

### Effect of Bentonite/Poly-DADMAC Stirring Time

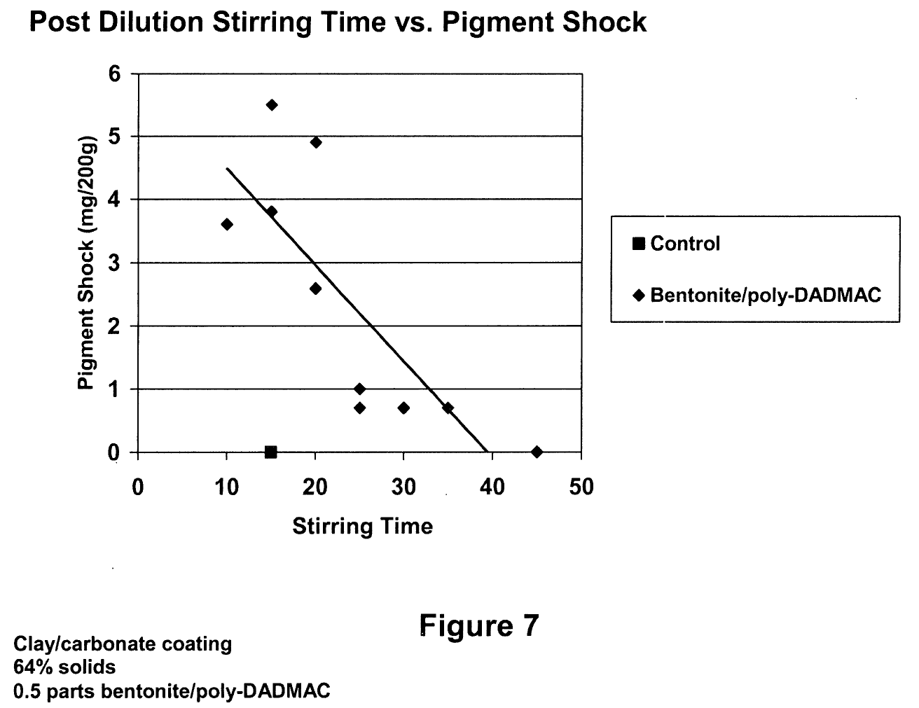

The amount of pigment shock (hard grit in the coating) formed by the addition of the bentonite/poly-DADMAC pre-mix describe in Example 4 was measured 10, 15, 20, 25, and 30 minutes after dilution from 25% total solids to 5% total solids. The clay/carbonate coating formulation described in Example 3 was used for the evaluation (64% solids). As shown in FIG. 7, the amount of pigment shock formed by the addition of the bentonite/poly-DADMAC pre-mix to the coating decreased steadily for the first 25 minutes of stirring after dilution. Longer stirring times had no beneficial effect on the amount of pigment shock formed in the paper coating. Based on these results, a stirring time of at least 25 minutes after dilution of a high solids pre-mix is preferred. The work was carried out at room temperature. Shorter times may be sufficient at higher temperatures.

### Example 13

### Immobilization of Coating Solids

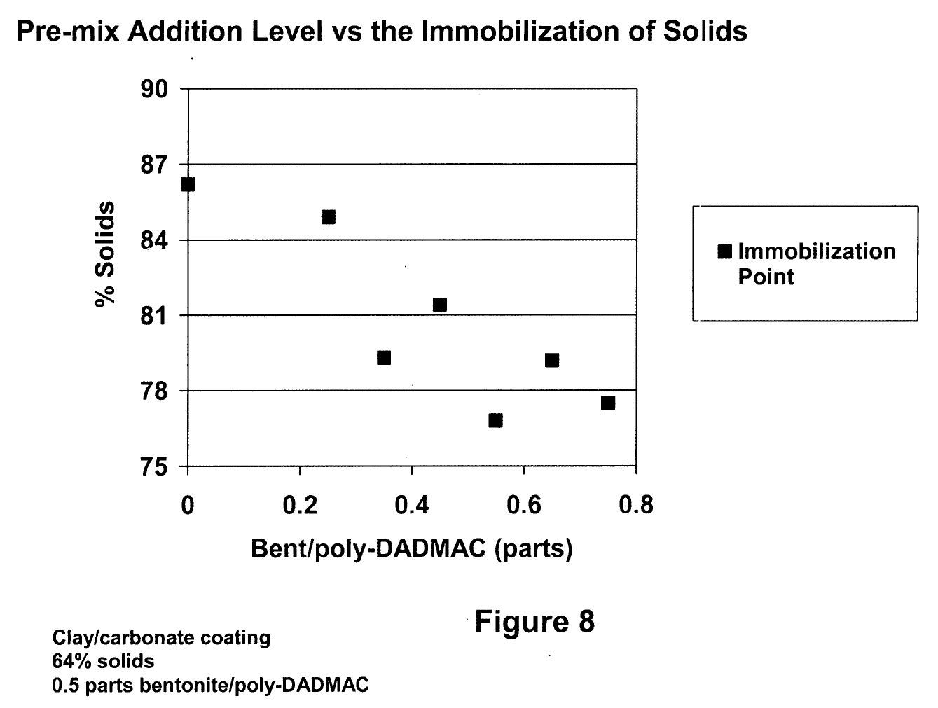

Rapid immobilization of coating solids (immobilization at lower % solids as the coating dries) has been linked to increased coating brightness and opacity. The effect of the HPG stabilized bentonite:poly-DADMAC pre-mix described in Example 4 on the immobilization of coating solids was measured over a range of pre-mix addition levels. The clay/carbonate coating described in Example 3 was used for the study. The pre-mix was diluted to 5% solids, and then stirred for 25 minutes before it was added to the coating formulation. In each case, coating solids was adjusted to 64% after pre-mix addition. As shown in FIG. 8, the coating immobilization point decreased steadily as the pre-mix addition level increased. These results show that the bentonite:poly-DADMAC pre-mix can be used to control the immobilization of coating solids.

### Example 14

### Zeta Potentials of Bentonite:Poly-DADMAC Pre-mixes and Treated Clay/Carbonate Coating

The zeta potentials of the particles in a series of bentonite:PRP-4440 poly-DADMAC pre-mixes were measured using a Malvern Zeta Sizer and the method described by Lauzon (U.S. Pat. No. 5,169,441, which is incorporated by reference herein). The pre-mixes were made using the method described in Example 1. As shown in Table 7, the particles in all four pre-mixes carried a positive zeta potential. Untreated bentonite clay is well known to have a negative zeta potential. The positive zeta potentials measured in this study confirm that the cationic poly-DADMAC polymer is intimately associated with the bentonite clay particles.

An analysis of the pigment particles in an untreated sample of the clay/carbonate coating described in Example 3, showed that the particles carried a negative zeta potential between −25 and −28 millivolts. The pigment particles in the clay/carbonate coating still carried a negative zeta potential (−24.8 millivolts) after the coating was treated with 0.75 parts of the 85:15 bentonite:poly-DADMAC pre-mix. These results confirm that the addition of the bentonite:poly-DADMAC pre-mix does not create a “cationic” coating as described in the prior art.

TABLE 7

| Pre-mix | Zeta Potential |
|---|---|
| 95:5 Bentonite:PRP-4440 | +30.0 millivolts |
| 85:15 Bentonite:PRP-4440 | +54.7 millivolts |
| 75:25 Bentonite:PRP-4440 | +64.7 millivolts |
| 65:35 Bentonite:PRP-4440 | +65.0 millivolts |

### Example 15

### Range of Cationic Polymers

Bentonite pre-mixes were made using a wide range of cationic polymers. The cationic polymers that were tested included:Perform® 1279 (Hercules, a branched dimethylamine/ethylenediamine/epichlorohydrine polymer, M_{w}=500,000, 5.8 milliequivalents/g positive charge), a low molecular weight (M_{w}=75,000, 5.8 milliequivalents/gram positive charge) dimethylamine/ethylenediamine/epichlorohydrin polymer available from Aldrich, Kymene® 557 (Hercules, a polyamideamine epichlorohydrin wet strength resin described in U.S. Pat. No. 2,926,154, 2.2 milliequivalents/gram positive charge at pH 8), Kymene® 736 (Hercules, a hexamethylenediamine/epichlorohydrin copolymer described in U.S. Pat. Nos. 3,655,506, 3,248,353, and 2,595,935, 4.0 milliequivalents/g positive charge at pH 8), polyethyleneimine (PEI, M_{w}=50,000, available from Aldrich, approximately 8 milliequivalents/g at pH 8), and an acrylamide/diallyldimethylammonium chloride copolymer (available from Aldrich, approximately 3 milliequivalents/g positive charge). In each case, bentonite pre-mixes were made over a wide range of cationic polymer addition levels. A high surface area bentonite clay (Bentolite H, Southern Clay Products) was used as the anionic particle of the pre-mix. The pre-mixes were made using the method described in Example 1. The polyethyleneimine sample was neutralized to pH 8 using 10% HCl prior to preparation of the pre-mix. The pre-mixes were not filtered after sonication.

Each of the bentonite/cationic polymer pre-mixes was then tested for its effect on Brookfield viscosity and pigment shock in the kaolin clay/ground calcium carbonate based coating described in Example 3. Direct addition of each of the cationic polymers was also tested in an effort to quantify the benefits of pre-forming the pre-mixes. An untreated coating was tested as a control. As described in Examples 7 and 8, the addition concentration of the cationic polymer can have a significant effect on its performance. For direct addition of a cationic polymer, its solution concentration was fixed at 0.75% solids. Each pre-mix addition concentration was selected to give the same cationic polymer addition concentration (0.75%) over the entire range of bentonite/cationic polymer ratios. Therefore, the % total solids of each pre-mix varied with the ratio of bentonite to cationic polymer (See Tables 8-11). In general, the increase in coating viscosity obtained at a given cationic polymer addition level increased as the percentage of cationic polymer in the pre-mix increased. Therefore, the addition level of each pre-mix was adjusted to give a coating viscosity equal to or higher than the viscosity obtained by direct addition of the corresponding cationic polymer. The amount of pigment shock in each of the treated coatings was determined by measuring the amount of grit retained on a 200 mesh screen using the method described in Example 7. The results obtained with each of the cationic polymers is described below.

Perform 1279 Dimethylamine/Ethylenediamine/Epichlorohydrin Co-polymer Pre-mixes

Bentonite/cationic polymer pre-mixes were made over Perform 1279 addition levels ranging from 10% to 70% (See Table 8, 90% to 30% bentonite).

Direct addition of Perform 1279 cationic polymer gave heavy pigment shock. All of the bentonite/Perform 1279 pre-mixes gave less pigment shock than direct addition of Perform 1279, when compared at equal coating viscosity. The pre-mixes containing between 10% and 20% Perform 1279 gave the best balance of increased coating viscosity and low levels of pigment shock. Based on these results, pre-mixes containing between 10% and 70% Perform 1279 (90%-30% bentonite) are preferred. Pre-mixes containing 10%-20% Perform 1279 (80%-90% bentonite) are more preferred.

Dimethylamine/Ethylenediamine/Epichlorohydrin Co-polymer (DMA-epi) Pre-mixes

Bentonite pre-mixes were also made using a lower molecular weight branched, dimethylamine/ethylenediamine/epichlorohydrin copolymer (M_{w}=75,000 daltons, Aldrich, Milwaukee, Wis., approximately 5.8 milliequivalents per gram). As shown in Table 9, bentonite/cationic polymer pre-mixes were made at DMA-epi addition levels ranging from 10% to 90% (90% to 10% bentonite).

Direct addition of the low molecular weight DMA-epi cationic polymer gave heavy pigment shock. All of the bentonite/DMA-epi pre-mixes gave less pigment shock than direct addition of the cationic polymer, when compared at equal coating viscosity. The pre-mixes containing between 20% and 60% low molecular weight DMA-epi cationic polymer gave the best balance of increased coating viscosity and low levels of pigment shock.

Based on these results, pre-mixes containing between 10% and 90% DMA-epi (90%-10% bentonite) are preferred. Pre-mixes containing 20%-60% DMA-epi (80%-40% bentonite) are more preferred.

It should also be noted that the low molecular weight DMA-epi cationic polymer gave larger increases in coating viscosity and less pigment shock than Perform 1279 (a high molecular weight DMA-epi cationic polymer). Based on these results, and the results obtained for the low and high molecular weight poly-DADMAC's (PRP-4440 and Reten 203), cationic polymers having molecular weights from about 10,000 to about 1,000,000 daltons are preferred. Cationic polymers with molecular weights from about 20,000 to about 500,000 daltons are more preferred.

Kymene 557 Polyamideamine/Epichlorohydrin Pre-mixes

As shown in Table 10, bentonite/cationic polymer pre-mixes were made at Kymene 557 addition levels ranging from 10% to 90% (90% to 10% bentonite).

Direct addition of Kymene 557 to the coating gave moderate-to-heavy pigment shock. The degree of pigment shock increased as Kymene 557 addition level increased. When compared at equal coating viscosity, the pre-mixes made at Kymene 557 addition levels between 50% and 70% (50%-30% bentonite) gave the best results. Pre-mixes made over this range of polymer addition levels gave increases in coating viscosity comparable to the increase obtained by direct addition of Kymene 557 with much less pigment shock. Pre-mixes made at lower, and higher, Kymene 557 addition levels gave only slightly less pigment shock than direct addition of Kymene 557, when compared at equal levels of coating viscosity

Based on these results, pre-mixes containing between 50% and 70% Kymene 557 (50%-30% bentonite) are preferred. This range of Kymene 557 addition levels is much higher than the range preferred by Lauzon (7.6% Kymene 557 on bentonite). Finally, it should be noted that the relatively low charge density Kymene 557 cationic polymer did not increase coating viscosity as efficiently as the higher charge density poly-DADMAC and DMA-epi polymers.

Polyamine Epichlorohydrin (Kymene 736) Cationic Polymer/Bentonite Pre-mixes

As shown in Table 11, bentonite/cationic polymer pre-mixes were made at Kymene 736 addition levels ranging from 10% to 90% (90% to 10% bentonite). Direct addition of Kymene 736 to the coating gave heavy pigment shock. The pre-mixes made at Kymene 736 concentrations between 30% and 70% (70%-30% bentonite) gave the best results. Pre-mixes made over this range of Kymene 736 addition levels gave increases in coating viscosity comparable to the increase obtained by direct addition of Kymene 736 with much less pigment shock. Pre-mixes made at lower Kymene 736 addition levels gave low levels of pigment shock, but were much less efficient at increasing coating viscosity than the pre-mixes made at 30%-70% Kymene 736. The Kymene 736/bentonite pre-mixes made at 80% and 90% Kymene 736 gave large increases in coating viscosity with somewhat less pigment shock than direct addition of Kymene 736.

Based on these results, pre-mixes containing 10% to 90% Kymene 736 (90%-10% bentonite) are preferred. Pre-mixes containing between 10% and 70% Kymene 736 (90%-30% bentonite) are more preferred. Pre-mixes containing between 30% and 70% Kymene 736 (70%-30% bentonite) are most preferred.

Finally, it should be noted that the relatively high charge density Kymene 736 gave larger increases in coating viscosity than the lower charge density Kymene 557.

Acrylamide/DADMAC Copolymer and PEI/Bentonite Pre-mixes

Cationic polymer/bentonite pre-mixes were made at acrylamide/DADMAC copolymer and PEI addition levels ranging from 10% to 90% (90% to 10% bentonite). None of the pre-mixes gave the desired results. The acrylamide/DADMAC copolymer gave flocced pre-mixes that caused heavy pigment shock. The cause of the PEI pre-mixes' poor performance is not understood at this time. Perhaps a lower molecular weight, less branched, or chemically modified version of the polymers would give the desired results. As described in Example 17, better results were obtained when a high surface area silica was used as the anionic particle instead of bentonite.

### Example 16

### Range of Anionic Inorganic Particles

A series of pre-mixes was made using silica or aluminum-modified silica as the anionic particle. The pre-mixes were made using the method described in Example 2. The silicas that were used were: Ludox TM (22 nm particle size, 135 m²/g), Ludox HS (12 nm particle size, 220 m²/g), and Ludox FM (5 nm particle size, 420 m²/g). All three silicas are available from Grace-Davison (Columbia, Md.). The aluminum-modified silicas that were used were:Ludox TMA (22 nm particle size, 140 m²/g) and Ludox AM (12 nm particle size, 220 m²/g). Both are available from Grace-Davison (Columbia, Md.). In each case, PRP-4440 poly-DADMAC was used as the cationic polymer component of the pre-mix. The pre-mixes were made over PRP-4440 addition levels ranging from 10% to 90% of total solids.

As shown in Tables 12-16, each of the pre-mixes was tested for its effect on Brookfield viscosity and pigment shock in the kaolin clay/ground calcium carbonate based coating described in Example 3. An untreated coating with a viscosity of 450-500 cps (Brookfield RV, 100 rpm) was tested as a control. Direct addition of PRP-4440 poly-DADMAC was also tested in an effort to quantify the benefits of pre-forming the pre-mix.

As described in Examples 7 and 8, the addition concentration of the cationic polymer can have a significant effect on its performance. For direct addition, the PRP-4440 solution concentration was fixed at 0.75% solids. Each pre-mix addition concentration was selected to give the same PRP-4440 poly-DADMAC addition concentration (0.75%) over the entire range of anionic particle/cationic polymer ratios. Therefore, the % total solids of each pre-mix varied with the ratio of anionic particle to cationic polymer (See Tables 12-16). As observed in previous Examples, the increase in coating viscosity obtained at a given cationic polymer addition level increased as the percentage of cationic polymer in the pre-mix increased. Therefore, the addition level of each pre-mix was adjusted to give a coating viscosity equal to or higher than the viscosity obtained by direct addition of PRP-4440 (1500-2000 cps, See Tables 12-16). The amount of pigment shock in each of the treated coatings was determined by measuring the amount of grit retained on a 200 mesh screen using the method described in Example 7. Direct addition of 0.075 parts PRP-4440 typically gave 5-15 mg of grit per 200 g of coating (See Tables 12-16). The results obtained with each of the silica and aluminum-modified silica anionic particles is described below.

Ludox TM Silica/PRP-4440 Pre-mixes

The Ludox TM pre-mixes made at PRP-4440 addition levels between 10% and 50% (See Table 12, 90%-50% Ludox TM) gave the desired results. The pre-mixes made over this range of addition levels gave large increases in coating viscosity with much less pigment shock than direct addition of PRP-4440. The best results were obtained at PRP-4440 addition levels between 15% and 50% (85%-50% Ludox TM). These pre-mixes built coating viscosity efficiently with little or no pigment shock. Higher PRP-4440 addition levels in the Ludox TM pre-mixes gave heavy pigment shock.

Based on these results, Ludox TM pre-mixes containing between 10% and 50% PRP-4440 (90%-50% Ludox TM) are preferred. Ludox TM pre-mixes containing between 15% and 50% PRP-4440 (85%-50% Ludox TM) are more preferred.

Ludox HS Silica/PRP-4440 Pre-mixes

The Ludox HS pre-mixes made at PRP-4440 addition levels between 15% and 90% (See Table 13, 85%-10% Ludox HS) gave the desired results. The pre-mixes made over this range of addition levels gave large increases in coating viscosity with much less pigment shock than direct addition of PRP-4440. Lower PRP-4440 addition levels (10%) gave poorly formed pre-mixes that formed grit in the coating.

Based on these results, Ludox HS pre-mixes containing between 15% and 90% PRP-4440 (85%-10% Ludox HS) are preferred.

Ludox FM Silica/PRP-4440 Pre-mixes

The Ludox FM pre-mixes made at PRP-4440 addition levels between 20% and 90% (See Table 14, 80%-10% Ludox HS) gave the desired results. The pre-mixes made over this range of addition levels gave large increases in coating viscosity with much less pigment shock than direct addition of PRP-4440. Lower PRP-4440 addition levels (10%-15%) gave poorly formed pre-mixes that formed grit in the coating.

Based on these results, Ludox FM pre-mixes containing between 20% and 90% PRP-4440 (80%-10% Ludox FM) are preferred.

It should be noted that Ludox HS and Ludox FM gave better results than Ludox TM, particularly at high PRP-4440 addition levels. This difference in performance is believed to be caused by differences in anionic particle size and surface area. Based on these results, silica particle sizes less than 50 nm are preferred. Silica particles sizes less than 20 nm are more preferred.

Ludox TMA Aluminum Modified Silica/PRP-4440 Pre-mixes

The Ludox TMA pre-mixes made at PRP-4440 addition levels between 10% and 90% (See Table 15, 90%-10% Ludox TMA) gave the desired results. The pre-mixes made over this range of addition levels gave large increases in coating viscosity with less pigment shock than direct addition of PRP-4440. The best results were obtained at PRP-4440 addition levels between 15% and 60% (85%-40% Ludox TMA). These pre-mixes built coating viscosity as efficiently as direct addition of PRP-4440 with little or no pigment shock. Higher PRP-4440 addition levels in the Ludox TMA pre-mixes gave slightly higher pigment shock. Lower PRP-4440 addition levels (10%) gave poorly formed pre-mixes that formed slightly higher pigment shock.

Based on these results, Ludox TMA pre-mixes containing between 10% and 90% PRP-4440 (90%-10% Ludox TMA) are preferred. Ludox TMA pre-mixes containing between 15% and 60% PRP-4440 (85%-40% Ludox TMA) are more preferred.

Ludox AM Aluminum Modified Silica/PRP-4440 Pre-mixes

The Ludox AM pre-mixes made at PRP-4440 addition levels between 10% and 90% (See Table 16, 90%-10% Ludox AM) gave the desired results. The pre-mixes made over this range of addition levels gave large increases in coating viscosity with less pigment shock than direct addition of PRP-4440. The best results were obtained at PRP-4440 addition levels between 15% and 60% (80%-40% Ludox AM). These pre-mixes built coating viscosity as efficiently as direct addition of PRP-4440 with little or no pigment shock. Higher PRP-4440 addition levels in the Ludox AM pre-mixes gave moderate pigment shock. Lower PRP-4440 addition levels (10%) gave poorly formed pre-mixes that formed moderate levels of grit in the coating.

Based on these results, Ludox AM pre-mixes containing between 10% and 90% PRP-4440 (90%-10% Ludox AM) are preferred. Ludox AM pre-mixes containing between 15% and 60% PRP-4440 (85%-40% Ludox AM) are more preferred.

### Example 17

### Polyethyleneimine/Silica Pre-mixes

PEI/Ludox HS silica pre-mixes were made at PEI addition levels ranging from 10% to 50% using the method described in Example 2. Each pre-mix was then tested for its effect on Brookfield viscosity and pigment shock in the kaolin clay/ground calcium carbonate based coating described in Example 3.

Direct addition of PEI to the paper coating gave very heavy pigment shock (See Table 17). PEI/Ludox HS pre-mixes made at PEI addition levels between 10% and 20% (90%-80% Ludox HS) gave the desired performance. The pre-mixes made over this range of addition levels gave large increases in coating viscosity with much less pigment shock than direct addition of PEI. Higher PEI addition levels gave heavy pigment shock. However, the pigment shock was still less than that caused by direct addition of PEI, when compared at equal coating viscosity.

Based on these results, Ludox HS pre-mixes containing between 10% and 50% PEI (90%-50% Ludox HS) are preferred. Ludox HS pre-mixes containing between 10% and 20% PEI (90%-80% Ludox HS) are more preferred.

### Example 18

### Acrylamide/DADMAC Copolymer/Silica Pre-mixes

Acrylamide/DADMAC copolymer/Ludox HS silica pre-mixes were made at acrylamide/DADMAC addition levels ranging from 10% to 90% using the method described in Example 2. Each pre-mix was then tested for its effect on Brookfield viscosity and pigment shock in the kaolin clay/ground calcium carbonate based coating described in Example 3.

Direct addition of the acrylamide/DADMAC copolymer to the paper coating gave very heavy pigment shock (See Table 18). Only the acrylamide/DADMAC copolymer/Ludox HS pre-mix made at the 70% addition level gave the desired performance. Lower acrylamide/DADMAC addition levels gave flocced pre-mixes that performed poorly. Higher acrylamide/DADMAC copolymer addition levels gave heavy pigment shock. Based on these results, Ludox HS pre-mixes containing approximately 70% acrylamide/DADMAC copolymer (30% Ludox HS) are preferred. It is likely that other acrylamide/DADMAC copolymers made with different molar ratios of acrylamide and poly-DADMAC, or made at different molecular weights, will give better performance.

### Example 19

### CLC Evaluation of Bentonite and Silica Pre-mixes

Based on the results of Examples 15 and 16, a series of pre-mixes was selected for evaluation on a cylindrical lab coater. PRP-4440, Reten 203, the 75,000 M_{w} DMA-epi cationic polymer, Kymene 557, and Kymene 736 were tested as the cationic polymer component of the pre-mixes. Bentonite, silica, and aluminum-modified silica were tested as the anionic particle component of the pre-mixes. The pre-mix formulations that were selected are shown in Table 19. The 85:15 bentonite:poly-DADMAC pre-mix was made at 25% solids using the method described in Example 5. The remaining pre-mixes were made using the methods described in Examples 1 and 2. The clay/carbonate coating formulation described in Example 3 and the cylindrical lab coater method described in Example 10 were used for the evaluation. In each case, pre-mix addition level was selected to give a cationic polymer addition level of 0.075 parts based on coating pigment, and a cationic polymer addition concentration of 0.75%. Each pre-mix was stirred at the selected addition concentration for at least 25 minutes before addition to the coating. The 85:15 bentonite:poly-DADMAC pre-mix was also tested using direct addition to the coating starch without dilution. An untreated coating was evaluated as a control. Standard TAPPI (Technical Association of the Pulp and Paper Industry) methods were used to measure coated paper opacity and brightness.

The pre-mixes made with the low molecular weight, high charge density poly-DADMAC, PRP-4440, gave the best results (See Table 19). The 85:15 bentonite:PRP-4440 pre-mix gave 0.4-0.8 point increases in opacity and brightness per coated side versus the untreated control. Excellent results were obtained when the pre-mix was diluted to 5% solids and added to the finished coating formulation, and when the undiluted pre-mix was added to the coating starch as part of the normal coating make-down procedure. The 70:30 bentonite:PRP-4440 pre-mix gave similar increases in opacity and brightness. The silica and aluminum-modified silica pre-mixes made with PRP-4440 poly-DADMAC also significantly improved the optical properties of the coated paper, particularly opacity.

The pre-mixes made with Reten 203, the 75,000 M_{w} DMA-epi cationic polymer, Kymene 557, and Kymene 736 gave smaller increases in coating opacity and brightness. In general, the pre-mixes made with high charge density cationic polymers gave larger increases in opacity and brightness than the pre-mixes made with low charge density cationic polymers. For example, the pre-mixes made with Reten 203 or the 75,000 M_{w} DMA-epi cationic polymer gave 0.2-0.5 point (per coated side) increases in coating opacity and brightness versus the untreated control. The bentonite pre-mixes made with the relatively low charge density Kymene 557 and Kymene 736 cationic polymers gave only small increases in coating opacity and brightness (0-0.3 points per coated side). It is likely that the Kymene 557 and Kymene 736 based pre-mixes would give larger increases in opacity and brightness at addition levels higher than the 0.075 parts cationic polymer used in this study.

Based on these results, cationic polymers with a cationic charge density of at least 2 milliequivalents per gram are preferred. Cationic polymers with a charge density of at least 4 milliequivalents per gram are more preferred. Poly-DADMAC cationic polymers are most preferred. The pre-mixes can be made using either bentonite, silica, or aluminum-modified silica as the anionic particle.

TABLE 4

| % Solids | | | | | | | |
|---|---|---|---|---|---|---|---|
| (Bent./Cat. | Hydroxy | Initial | Settling Stability | | | | |
| Polymer | Propyl Guar | Viscosity | 1 Day | 1 Week | 2 Weeks | 4 Weeks | 8 Weeks |
| 21% | 0.4% | 732 cps | pass | thin clear | — | — | — |
| | | | | layer failed | | | |
| 21% | 0.6% | 1760 cps | pass | pass | thin clear | — | — |
| | | | | | layer failed | | |
| 21% | 0.7% | 2170 cps | pass | pass | thin clear | — | — |
| | | | | | layer failed | | |
| 21% | 0.8% | 2770 cps | pass | pass | pass | pass | thin clear |
| | | | | | | | layer failed |
| 24% | 0.4% | 1020 cps | pass | thin clear | — | — | — |
| | | | | layer failed | | | |
| 24% | 0.6% | 2060 cps | pass | pass | pass | thin clear | — |
| | | | | | | layer failed | |
| 24% | 0.7% | 2590 cps | pass | pass | pass | pass | thin clear |
| | | | | | | | layer failed |
| 24% | 0.8% | 3390 cps | pass | pass | pass | pass | pass |
| 27% | 0.4% | 1200 cps | pass | thin clear | — | — | — |
| | | | | layer failed | | | |
| 27% | 0.5% | 1750 cps | pass | pass | pass | thin clear | — |
| | | | | | | layer failed | |
| 27% | 0.6% | 2510 cps | pass | pass | pass | pass | thin clear |
| | | | | | | | layer failed |
| 27% | 0.7% | 3080 cps | pass | pass | pass | pass | pass |
| 30% | 0.3% | 988 cps | pass | thin clear | — | — | — |
| | | | | layer failed | | | |
| 30% | 0.4% | 1610 cps | pass | pass | thin clear | — | — |
| | | | | | layer failed | | |
| 30% | 0.5% | 2220 cps | pass | pass | pass | pass | thin clear |
| | | | | | | | layer failed |
| 30% | 0.6% | 3140 cps | pass | pass | pass | pass | pass |

TABLE 5
Bentonite/Reten 203 - Coating Viscosity and Pigment Shock

| | | | | | | Pigment |
|---|---|---|---|---|---|---|
| | Bentonite/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 470 cps | 0.3 mg |
| Reten 203 | Direct Addition | — | 0.75% | 0.060% | 965 cps | 3.5 mg |
| Reten 203 | Direct Addition | — | 0.75% | 0.075% | 1690 cps | 3.2 mg |
| Reten 203 | Direct Addition | — | 0.75% | 0.085% | 2300 cps | 5.1 mg |
| Reten 203 | 95/5 | 15% | 0.75% | 0.10% | 1475 cps | 5.9 mg |
| Reten 203 | 92.5/7.5 | 10% | 0.75% | 0.10% | 2000 cps | 4.1 mg |
| Reten 203 | 90/10 | 7.5% | 0.75% | 0.10% | 2180 cps | 4.5 mg |
| Reten 203 | 85/15 | 5.0% | 0.75% | 0.10% | 2450 cps | 1.8 mg |
| Reten 203 | 80/20 | 3.75% | 0.75% | 0.10% | 2820 cps | 0.7 mg |
| Reten 203 | 75/25 | 3.0% | 0.75% | 0.085% | 3000 cps | 1.3 mg |
| Reten 203 | 70/30 | 2.5% | 0.75% | 0.085% | 3120 cps | 1.7 mg |
| Reten 203 | 60/40 | 1.88% | 0.75% | 0.085% | 2450 cps | 1.8 mg |
| Reten 203 | 50/50 | 1.5% | 0.75% | 0.085% | 2520 cps | 6.5 mg |

TABLE 6
Bentonite/PRP-4440 - Coating Viscosity and Pigment Shock

| | | | | | | Pigment |
|---|---|---|---|---|---|---|
| | Bentonite/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 480 cps | 0.1 mg |
| PRP-4440 | Direct Addition | — | 0.75% | 0.075% | 1980 cps | 11.1 mg |
| PRP-4440 | Direct Addition | — | 0.75% | 0.075% | 2180 cps | 7.9 mg |
| PRP-4440 | 95/5 | 15% | 0.75% | 0.10% | 1250 cps | 6.7 mg |
| PRP-4440 | 92.5/7.5 | 10% | 0.75% | 0.10% | 1730 cps | 2.3 mg |
| PRP-4440 | 90/10 | 7.5% | 0.75% | 0.10% | 1995 cps | 1.6 mg |
| PRP-4440 | 85/15 | 5.0% | 0.75% | 0.10% | 2530 cps | 0.7 mg |
| PRP-4440 | 80/20 | 3.75% | 0.75% | 0.10% | 2220 cps | 1.9 mg |
| PRP-4440 | 75/25 | 3.0% | 0.75% | 0.085% | 2190 cps | 0.1 mg |
| PRP-4440 | 70/30 | 2.5% | 0.75% | 0.085% | 2160 cps | 1.0 mg |
| PRP-4440 | 60/40 | 1.88% | 0.75% | 0.085% | 2420 cps | 4.9 mg |
| PRP-4440 | 50/50 | 1.5% | 0.75% | 0.075% | 1850 cps | 7.4 mg |

TABLE 8
Bentonite/Perform 1279 DMA-Epi, M_{w} - 500,000 -
Coating Viscosity and Pigment Shock

| | | | | | | Pigment |
|---|---|---|---|---|---|---|
| | Bentonite/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 470 cps | 0.0 mg |
| Perform 1279 | Direct Addition | — | 0.75% | 0.075% | 1060 cps | 23.3 mg |
| Perform 1279 | 90/10 | 7.5% | 0.75% | 0.10% | 925 cps | 3.7 mg |
| Perform 1279 | 80/20 | 3.75% | 0.75% | 0.10% | 1080 cps | 4.2 mg |
| Perform 1279 | 70/30 | 2.5% | 0.75% | 0.10% | 1340 cps | 8.4 mg |
| Perform 1279 | 60/40 | 1.88% | 0.75% | 0.10% | 1710 cps | 10.7 mg |
| Perform 1279 | 50/50 | 1.5% | 0.75% | 0.085% | 1250 cps | 14.4 mg |
| Perform 1279 | 40/60 | 1.25% | 0.75% | 0.085% | 1360 cps | 15.2 mg |
| Perform 1279 | 30/70 | 1.07% | 0.75% | 0.085% | 1810 cps | 16.5 mg |

TABLE 9
Bentonite/DMA-Epi, M_{w} - 75,000 - Coating Viscosity and Pigment Shock

| | | | | | | Pigment |
|---|---|---|---|---|---|---|
| | Bentonite/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 450 cps | 0.0 mg |
| DMA-Epi M_{w} - 75,000 | Direct Addition | — | 0.75% | 0.075% | 1140 cps | 29.7 mg |
| DMA-Epi M_{w} - 75,000 | 90/10 | 7.5% | 0.75% | 0.10% | 900 cps | 4.0 mg |
| DMA-Epi M_{w} - 75,000 | 80/20 | 3.75% | 0.75% | 0.10% | 1150 cps | 0.6 mg |
| DMA-Epi M_{w} - 75,000 | 70/30 | 2.5% | 0.75% | 0.10% | 1560 cps | 0.6 mg |
| DMA-Epi M_{w} - 75,000 | 60/40 | 1.88% | 0.75% | 0.10% | 1920 cps | 0.9 mg |
| DMA-Epi M_{w} - 75,000 | 50/50 | 1.5% | 0.75% | 0.085% | 1900 cps | 1.5 mg |
| DMA-Epi M_{w} - 75,000 | 40/60 | 1.25% | 0.75% | 0.075% | 1300 cps | 1.7 mg |
| DMA-Epi M_{w} - 75,000 | 30/70 | 1.07% | 0.75% | 0.075% | 1380 cps | 5.7 mg |
| DMA-Epi M_{w} - 75,000 | 20/80 | 0.94% | 0.75% | 0.075% | 1490 cps | 5.2 mg |
| DMA-Epi M_{w} - 75,000 | 10/90 | 0.84% | 0.75% | 0.075% | 1700 cps | 4.4 mg |

TABLE 10
Bentonite/Kymene 557 - Coating Viscosity and Pigment Shock

| | | | | | | Pigment |
|---|---|---|---|---|---|---|
| | Bentonite/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 470 cps | 0.3 mg |
| Kymene 557 | Direct Addition | — | 0.75% | 0.065% | 685 cps | 2.9 mg |
| Kymene 557 | Direct Addition | — | 0.75% | 0.075% | 800 cps | 5.2 mg |
| Kymene 557 | Direct Addition | — | 0.75% | 0.10% | 960 cps | 15.4 mg |
| Kymene 557 | 90/10 | 7.5% | 0.75% | 0.10% | 576 cps | 2.3 mg |
| Kymene 557 | 80/20 | 3.75% | 0.75% | 0.10% | 752 cps | 2.3 mg |
| Kymene 557 | 70/30 | 2.5% | 0.75% | 0.10% | 670 cps | 2.0 mg |
| Kymene 557 | 60/40 | 1.88% | 0.75% | 0.10% | 650 cps | 2.4 mg |
| Kymene 557 | 50/50 | 1.5% | 0.75% | 0.10% | 710 cps | 0.2 mg |
| Kymene 557 | 40/60 | 1.25% | 0.75% | 0.10% | 720 cps | 0.1 mg |
| Kymene 557 | 30/70 | 1.07% | 0.75% | 0.10% | 772 cps | 0.8 mg |
| Kymene 557 | 20/80 | 0.94% | 0.75% | 0.10% | 920 cps | 5.5 mg |
| Kymene 557 | 10/90 | 0.84% | 0.75% | 0.10% | 910 cps | 3.2 mg |

TABLE 11
Kymene 736 - Coating Viscosity and Pigment Shock

| | | | | | | Pigment |
|---|---|---|---|---|---|---|
| | Bentonite/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 448 cps | 0.7 mg |
| Kymene 736 | Direct Addition | — | 0.75% | 0.075% | 1580 cps | 9.6 mg |
| Kymene 736 | 90/10 | 7.5% | 0.75% | 0.10% | 688 cps | 1.9 mg |
| Kymene 736 | 80/20 | 3.75% | 0.75% | 0.10% | 1060 cps | 0.8 mg |
| Kymene 736 | 70/30 | 2.5% | 0.75% | 0.10% | 1920 cps | 0.0 mg |
| Kymene 736 | 60/40 | 1.88% | 0.75% | 0.085% | 1710 cps | 1.8 mg |
| Kymene 736 | 50/50 | 1.5% | 0.75% | 0.085% | 2000 cps | 0.8 mg |
| Kymene 736 | 40/60 | 1.25% | 0.75% | 0.085% | 2590 cps | 2.0 mg |
| Kymene 736 | 30/70 | 1.07% | 0.75% | 0.075% | 1740 cps | 0.6 mg |
| Kymene 736 | 20/80 | 0.94% | 0.75% | 0.075% | 2080 cps | 2.8 mg |
| Kymene 736 | 10/90 | 0.84% | 0.75% | 0.075% | 2210 cps | 3.2 mg |

TABLE 12
Ludox TM-50/PRP-4440 - Coating Viscosity and Pigment Shock

| | Anionic | | | | | Pigment |
|---|---|---|---|---|---|---|
| | Particle/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 470 cps | 0.2 mg |
| Control | Direct Addition | — | — | — | 478 cps | 0.1 mg |
| PRP-4440 | Direct Addition | — | 0.75% | 0.075% | 2050 cps | 5.0 mg |
| PRP-4440 | Direct Addition | — | 0.75% | 0.075% | 1760 cps | 8.0 mg |
| PRP-4440 | 90/10 | 7.5% | 0.75% | 0.085% | 1330 cps | 0.8 mg |
| PRP-4440 | 90/10 | 7.5% | 0.75% | 0.090% | 1610 cps | 1.1 mg |
| PRP-4440 | 85/15 | 5.0% | 0.75% | 0.090% | 2980 cps | 0.4 mg |
| PRP-4440 | 80/20 | 3.75% | 0.75% | 0.085% | 2580 cps | 1.1 mg |
| PRP-4440 | 70/30 | 2.5% | 0.75% | 0.075% | 2270 cps | 1.2 mg |
| PRP-4440 | 60/40 | 1.88% | 0.75% | 0.075% | 1890 cps | 0.3 mg |
| PRP-4440 | 50/50 | 1.5% | 0.75% | 0.075% | 2540 cps | 0.7 mg |
| PRP-4440 | 40/60 | 1.25% | 0.75% | 0.075% | 2170 cps | 11.4 mg |
| PRP-4440 | 40/60 | 1.25% | 0.75% | 0.075% | 2225 cps | 18.5 mg |
| PRP-4440 | 30/70 | 1.07% | 0.75% | 0.065% | 1640 cps | 10.8 mg |
| PRP-4440 | 20/80 | 0.94% | 0.75% | 0.065% | 1735 cps | 10.3 mg |
| PRP-4440 | 10/90 | 0.84% | 0.75% | 0.065% | 1820 cps | 11.1 mg |

TABLE 13
Ludox HS/PRP-4440 - Coating Viscosity and Pigment Shock

| | Anionic | | | | | Pigment |
|---|---|---|---|---|---|---|
| | Particle/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 492 cps | 0.1 mg |
| PRP-4440 | Direct Addition | — | 0.75% | 0.075% | 1490 cps | 3.9 mg |
| PRP-4440 | 90/10 | 7.5% | 0.75% | 0.10% | 820 cps | 2.6 mg |
| PRP-4440 | 85/15 | 5.0% | 0.75% | 0.10% | 2330 cps | 0.3 mg |
| PRP-4440 | 80/20 | 3.75% | 0.75% | 0.10% | 1970 cps | 0.1 mg |
| PRP-4440 | 70/30 | 2.5% | 0.75% | 0.085% | 1620 cps | 0.7 mg |
| PRP-4440 | 60/40 | 1.88% | 0.75% | 0.085% | 1800 cps | 1.0 mg |
| PRP-4440 | 50/50 | 1.5% | 0.75% | 0.085% | 2410 cps | 0.8 mg |
| PRP-4440 | 40/60 | 1.25% | 0.75% | 0.075% | 1850 cps | 0.8 mg |
| PRP-4440 | 30/70 | 1.07% | 0.75% | 0.075% | 1620 cps | 0.6 mg |
| PRP-4440 | 20/80 | 0.94% | 0.75% | 0.075% | 1750 cps | 0.6 mg |
| PRP-4440 | 10/90 | 0.84% | 0.75% | 0.075% | 1970 cps | 0.7 mg |

TABLE 14
Ludox FM/PRP-4440 - Coating Viscosity and Pigment Shock

| | Anionic | | | | | Pigment |
|---|---|---|---|---|---|---|
| | Particle/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 455 cps | 0.3 mg |
| PRP-4440 | Direct Addition | — | 0.75% | 0.075% | 2015 cps | 14.4 mg |
| PRP-4440 | 90/10 | 7.5% | 0.75% | 0.10% | 905 cps | 59.1 mg |
| PRP-4440 | 85/15 | 5.0% | 0.75% | 0.10% | 664 cps | 4.7 mg |
| PRP-4440 | 80/20 | 3.75% | 0.75% | 0.10% | 1280 cps | 1.1 mg |
| PRP-4440 | 70/30 | 2.5% | 0.75% | 0.085% | 1890 cps | 1.1 mg |
| PRP-4440 | 60/40 | 1.88% | 0.75% | 0.085% | 2390 cps | 1.6 mg |
| PRP-4440 | 50/50 | 1.5% | 0.75% | 0.075% | 2010 cps | 1.9 mg |
| PRP-4440 | 40/60 | 1.25% | 0.75% | 0.075% | 2450 cps | 2.4 mg |
| PRP-4440 | 30/70 | 1.07% | 0.75% | 0.065% | 2410 cps | 1.7 mg |
| PRP-4440 | 20/80 | 0.94% | 0.75% | 0.060% | 1690 cps | 1.3 mg |
| PRP-4440 | 10/90 | 0.84% | 0.75% | 0.060% | 1910 cps | 1.2 mg |

TABLE 15
Ludox TMA/PRP-4440 - Coating Viscosity and Pigment Shock

| | Anionic | | | | | Pigment |
|---|---|---|---|---|---|---|
| | Particle/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 470 cps | 0.3 mg |
| PRP-4440 | Direct Addition | — | 0.75% | 0.065% | 1920 cps | 4.9 mg |
| PRP-4440 | Direct Addition | — | 0.75% | 0.075% | 2390 cps | 8.6 mg |
| PRP-4440 | 90/10 | 7.5% | 0.75% | 0.075% | 1870 cps | 2.0 mg |
| PRP-4440 | 85/15 | 5.0% | 0.75% | 0.070% | 1520 cps | 0.6 mg |
| PRP-4440 | 80/20 | 3.75% | 0.75% | 0.065% | 2250 cps | 0.8 mg |
| PRP-4440 | 70/30 | 2.5% | 0.75% | 0.060% | 1920 cps | 0.7 mg |
| PRP-4440 | 60/40 | 1.88% | 0.75% | 0.060% | 1760 cps | 0.7 mg |
| PRP-4440 | 50/50 | 1.5% | 0.75% | 0.060% | 1680 cps | 1.0 mg |
| PRP-4440 | 40/60 | 1.25% | 0.75% | 0.060% | 1790 cps | 0.8 mg |
| PRP-4440 | 30/70 | 1.07% | 0.75% | 0.065% | 2360 cps | 1.5 mg |
| PRP-4440 | 20/80 | 0.94% | 0.75% | 0.065% | 2230 cps | 1.6 mg |
| PRP-4440 | 10/90 | 0.84% | 0.75% | 0.065% | 2320 cps | 1.5 mg |

TABLE 16
Ludox AM/PRP-4440 - Coating Viscosity and Pigment Shock

| | Anionic | | | | | Pigment |
|---|---|---|---|---|---|---|
| | Particle/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 452 cps | 0.0 mg |
| PRP-4440 | Direct Addition | — | 0.75% | 0.075% | 1800 cps | 32.7 mg |
| PRP-4440 | 90/10 | 7.5% | 0.75% | 0.085% | 1685 cps | 6.5 mg |
| PRP-4440 | 85/15 | 5.0% | 0.75% | 0.085% | 1410 cps | 0.3 mg |
| PRP-4440 | 80/20 | 3.75% | 0.75% | 0.085% | 2280 cps | 0.1 mg |
| PRP-4440 | 70/30 | 2.5% | 0.75% | 0.075% | 2210 cps | 0.9 mg |
| PRP-4440 | 60/40 | 1.88% | 0.75% | 0.070% | 2040 cps | 0.4 mg |
| PRP-4440 | 50/50 | 1.5% | 0.75% | 0.065% | 1675 cps | 0.4 mg |
| PRP-4440 | 40/60 | 1.25% | 0.75% | 0.065% | 1890 cps | 0.4 mg |
| PRP-4440 | 30/70 | 1.07% | 0.75% | 0.065% | 2020 cps | 2.5 mg |
| PRP-4440 | 20/80 | 0.94% | 0.75% | 0.060% | 1710 cps | 2.8 mg |
| PRP-4440 | 10/90 | 0.84% | 0.75% | 0.060% | 2240 cps | 2.1 mg |

TABLE 17
Polyethyleneimine (PEI)/HS-40 Silica - Coating Viscosity and Pigment Shock

| | Anionic | | | | | Pigment |
|---|---|---|---|---|---|---|
| | Particle/ | % Solids | % Solids | Polymer | Coating | Shock |
| Polymer | Polymer Ratio | Pre-mix | Polymer | Add'n Level | Viscosity | (mg/200 g) |
| Control | Blank | — | — | — | 480 cps | 1.4 mg |
| PEI | Direct Addition | — | 0.75% | 0.065% | 1260 cps | 5.7 mg |
| PEI | Direct Addition | — | 0.75% | 0.075% | 1780 cps | 115.6 mg |
| PEI | 90/10 | 7.5% | 0.75% | 0.085% | 1100 cps | 0.5 mg |
| PEI | 90/10 | 7.5% | 0.75% | 0.10% | 1260 cps | 1.5 mg |
| PEI | 80/20 | 3.75% | 0.75% | 0.085% | 1620 cps | 7.3 mg |
| PEI | 70/30 | 2.5% | 0.75% | 0.085% | 2310 cps | 20.7 mg |
| PEI | 60/40 | 1.88% | 0.75% | 0.085% | 2400 cps | 33.5 mg |
| PEI | 50/50 | 1.5% | 0.75% | 0.085% | 2980 cps | 31.5 mg |

TABLE 18
Acrylamide/DADMAC Copolymer (ACM/DADMAC)/HS-40
Silica - Coating Viscosity and Pigment Shock

| | Anionic | | | | | Pigment | |
|---|---|---|---|---|---|---|---|
| | Particle/ | % Solids | % Solids | Polymer | Coating | Shock | |
| Polymer | Polymer Ratio | Pre-mix | Polymer | Add'n Level | Viscosity | (mg/200 g) | |
| Control | Blank | — | — | — | 480 cps | 1.4 | mg |
| Acrylamide/ | Direct Addition | — | 0.75% | 0.075% | 944 cps | 79.8 | mg |
| DADMAC | | | | | | | |
| Acrylamide/ | 90/10 | 7.5% | 0.75% | 0.085% | 608 cps | 547 | mg |
| DADMAC | | | | | | | |
| Acrylamide/ | 70/30 | 2.5% | 0.75% | 0.10% | — | heavy pigment shock - | |
| DADMAC | | | | | | couldn't filter | |
| Acrylamide/ | 50/50 | 1.5% | 0.75% | 0.10% | — | heavy pigment shock - | |
| DADMAC | | | | | | couldn't filter | |
| Acrylamide/ | 40/60 | 1.25% | 0.75% | 0.10% | — | heavy pigment shock - | |
| DADMAC | | | | | | couldn't filter | |
| Acrylamide/ | 30/70 | 1.07% | 0.75% | 0.10% | 1210 cps | 12.8 | mg |
| DADMAC | | | | | | | |
| Acrylamide/ | 20/80 | 0.94% | 0.75% | 0.10% | 1240 cps | 51.2 | mg |
| DADMAC | | | | | | | |

| | | | | | | |
|---|---|---|---|---|---|---|
| Acrylamide/ | 10/90 | 0.84% | 0.75% | 0.10% | — | heavy pigment shock - |
| DADMAC | | | | | | couldn't filter |

TABLE 19
Brightness and Opacity Increase of Coated Paper

| | Average Increase | Average Increase |
|---|---|---|
| | in Coated Paper | in Coated Paper |
| Pre-mix | Brightness per Side | Opacity per Side |
| Untreated Control | — | — |
| 85:15: bentonite:PRP-4440 | 0.42 points | 0.84 points |
| diluted, added last | | |
| 85:15: bentonite:PRP-4440 | 0.39 points | 0.65 points |
| undiluted, added to starch | | |
| 70:30: bentonite:PRP-4440 | 0.62 points | 0.54 points |
| 85:15: bentonite:Reten 203 | 0.49 points | 0.23 points |
| 70:30 bentonite:75,000 M_{w} DMA-epi | 0.39 points | 0.42 points |
| 50:50 bentonite:Kymene 736 | 0.10 points | 0.31 points |
| 40:60 bentonite:Kymene 557 | 0.27 points | 0.0 points |
| 70:30 Ludox FM silica:PRP-4440 | 0.13 points | 0.65 points |
| 70:30 Ludox TM silica PRP-4440 | 0.23 points | 0.76 points |
| 70:30 Ludox AM aluminum-modified | 0.28 points | 0.67 points |
| silica:PRP-4440 | | |

1. A pigmented aqueous system comprising:
(i) an additive pre-mix comprising a cationic polymer and an anionic particle.

2. The system according to claim 1, wherein the system contains pre-mix in amounts ranging from about 0.01 to about 2.0 dry parts per 100 parts of pigment in the aqueous system.

3. The system according to claim 2, wherein the system contains pre-mix in amounts ranging from about 0.05 to about 1.0 dry parts per 100 parts of pigment in the aqueous system.

4. The system according to claim 3, wherein the system contains pre-mix in amounts ranging from about 0.1 to about 0.5 dry parts per 100 parts of pigment in the aqueous system.

5. The system according to claim 1, wherein the pre-mix has a solids content ranging from about 5% to about 40%.

6. The system according to claim 5, wherein the pre-mix has a solids content ranging from about 15% to about 30%.

7. The system according to claim 1, wherein the cationic polymer has a weight average molecular weight ranging from about 5,000 to about 3,000,000 daltons.

8. The system according to claim 7, wherein the cationic polymer has a weight average molecular weight ranging from about 10,000 to about 1,000,000 daltons.

9. The system according to claim 8, wherein the cationic polymer has a weight average molecular weight ranging from about 20,000 to about 500,000 daltons.

10. The system according to claim 1, wherein the cationic polymer has a charge density of about 0.1 to about 8 meq/gram.

11. The system according to claim 10, wherein the cationic polymer has a charge density of about 1 to about 8 meq/gram.

12. The system according to claim 11, wherein the cationic polymer has a charge density of about 2 to about 6.5 meq/gram.

13. The system according to claim 1, wherein the cationic polymer comprises quaternized salts of (co)polymers of N-alkylsubstituted aminoalkyl esters of (meth)acrylic acid; quaternized salts of reaction products of a polyamine and an acrylate type compound; (co)polymers of (methacryloyloxyethyl)trimethyl ammonium chloride; (co)polymers of acrylamide and quaternary ammonium compounds; quaternized vinyllactam-acrylamide (co)polymers; quaternized salt of hydroxy-containing polyesters of unsaturated carboxylic acids; quaternary ammonium salt of polyimide-amines; quaternized polyamines; quaternized reaction products of amines and polyesters; quaternized salt of condensation (co)polymers of polyethyleneamines with dichloroethane; quaternized condensation products of polyalkylene-polyamines and epoxy halides; quaternized condensation products of alkylene-polyamines and polyfunctional halohydrins; quaternized condensation products of alkylene-polyamines and halohydrins; quaternized condensation (co)polymers of ammonia and halohydrins; quaternized salt of polyvinylbenzyltrialkylamines; quaternized salt of (co)polymers of vinyl-heterocyclic monomers having a ring nitrogen; polydialkyldiallylammonium salt including polydiallyldimethyl ammonium chloride; (co)polymers of vinyl unsaturated acids, esters and amides thereof and diallyldialkylammonium salts; polymethacrylamidopropyltrimethylammonium chloride; quaternary ammonium salt of ammonia-ethylene dichloride condensation (co)polymers; quaternized salt of epoxy halide (co)polymers, and mixtures thereof.

14. The system according to claim 13, wherein the cationic polymer comprises (co)polymers of diallyldialkylammonium salts; (co)polymers of diallylamine; (co)polymers of diallylalkylamine; polyethylene imine; (co)polymers of dialkylamine/epichlorohydrin; (co)polymers of polyamine/epichlorohydrin; (co)polymers of polyamide/epichlorohydrin; (co)polymers of polyamideamine; (co)polymers of polyamideamine/epichlorohydrin; (co)polymers and quaternized (co)polymers of dialkylaminoalkyl acrylamide and methacrylamide; and (co)polymers and quaternized (co)polymers of dialkylaminoalkyl acrylate, methacrylate esters and mixtures thereof.

15. The system according to claim 14, wherein the cationic polymer comprises (co)polymers of diallyldimethylammonium salts; (co)polymers of polyamine/epichlorohydrin; polyethylene imine; (co)polymers of dimethylamine/epichlorohydrin; polyamideamine/epichlorohydrin polymers and mixtures thereof.

16. The system according to claim 15, wherein the cationic polymer comprises (co)polymers of diallyldimethylammonium salts, (co)polymers of dimethylamine/epichlorohydrin and mixtures thereof.

17. The system according to claim 1, wherein the cationic polymer has a concentration in the pre-mix of less than about 2.5%.

18. The system according to claim 17, wherein the cationic polymer has a concentration in the pre-mix of less than about 1.5%.

19. The system according to claim 18, wherein the cationic polymer has a concentration in the pre-mix of less than about 1.0%

20. The system according to claim 1, wherein the anionic particle is a high surface area anionically charged inorganic mineral, a high surface area anionically charged synthetic inorganic particle and mixtures thereof.

21. The system according to claim 20, wherein the anionic particle comprises swelling clay, sililca-based particles and mixtures thereof.

22. The system according to claim 21, wherein the silica-based particle comprises colloidal silica, colloidal aluminum-modified silica, aluminum silicate and mixtures thereof.

23. The system according to claim 21, wherein the swelling clay comprises bentonite, montmorillonite, montmorillinite, beidelite, nontronite, hectroite, saponite, sepialite or attapulgite.

24. The system according to claim 23, wherein the anionic particle is bentonite.

25. The system according to claim 21, wherein the swelling clay has a particle size ranging from about 1 nanometer to about 1 micrometer.

26. The system according to claim 21, where the swelling clay has a surface area of at least 50 m²/g.

27. The system according to claim 26, wherein the swelling clay has a surface area of at least 100 m²/g.

28. The system according to claim 27, wherein the swelling clay has a surface area of at least 200 m²/g.

29. The system according to claim 21, wherein the silica-based particle has a particle size below about 50 nanometers.

30. The system according to claim 29, wherein the silica-based particle has a particle size below about 20 nanometers.

31. The system according to claim 30, wherein the silica-based particle has a particle size ranging from about 1 to about 10 nanometers

32. The system according to claim 21, wherein the silica-based particle has a surface area of at least 50 m²/g.

33. The system according to claim 32, wherein the silica-based particle has a surface area of at least 100 m²/g.

34. The system according to claim 33, wherein the silica-based particle has a surface area of at least about 200 m²/g.

35. The system according to claim 1, wherein the additive premix comprises about 95 wt-% to about 10 wt-% of the anionic particle and about 5 wt-% to about 80 wt-% of the cationic polymer.

36. The system according to claim 35, wherein the additive pre-mix comprises about 90 wt-% to about 20 wt-% anionic particle and about 10 wt-% to about 80 wt-% of the cationic polymer.

37. The system according to claim 36, wherein the additive pre-mix comprises about 90 wt-% to about 40 wt-% of the anionic polymer and about 10 wt-% to about 60 wt-% of the cationic polymer.

38. The system according to claim 37, wherein the additive pre-mix comprises about 85 wt-% to about 60 wt-% of the anionic particle and about 15 wt-% to about 40 wt-% of the cationic polymer).

39. The system according to claim 1, wherein the anionic particle is bentonite and the cationic polymer is poly-DADMAC.

40. The system according to claim 39, wherein the bentonite and poly-DADMAC are in a ratio of about 92.5:7.5 to about 60:40 respectively.

41. The system according to claim 40, wherein the bentonite and poly-DADMAC are in a ratio of about 70:30 to about 85:15 respectively.

42. A paper coated with a coating comprising the pigmented aqueous system according to claim 1.

43. A process for forming an aqueous system comprising:
(1) mixing an anionic particle and a cationic polymer; wherein an additive pre-mix is formed,
(2) optionally filtering the additive pre-mix;
(3) optionally adding a stabilizing agent to the additive pre-mix;
(4) optionally adding the additive pre-mix to a coating starch;
(5) optionally adding a biocide to the additive pre-mix; and
(6) adding the additive pre-mix to an aqueous system.

44. The process according to claim 43, further comprising:
(7) coating a cellulose matrix; and
(8) drying the cellulose matrix.

45. The process according to claim 43, wherein the cationic polymer comprises (co)polymers of diallyidialkylammonium salts; (co)polymers of diallylamine; (co)polymers of diallylalkylamine; polyethylene imine, (co)polymers of dialkylamine/epichlorohydrin; (co)polymers of polyamine/epichlorohydrin; (co)polymers of polyamide/epichlorohydrin; (co)polymers of polyamideamine; (co)polymers of polyamideamine/epichlorohydrin; (co)polymers and quaternized (co)polymers of dialkylaminoalkyl acrylamide and methacrylamide; and (co)polymers and quaternized (co)polymers of dialkylaminoalkyl acrylate methacrylate esters and mixtures thereof.

46. The process according to claim 45, wherein the cationic polymer comprises (co)polymers of diallyldimethylammonium salts; (co)polymers of polyamine/epichlorohydrin; polyethylene imine; (co)polymers of dimethylamine/epichlorohydrin; polyamideamine/epichlorohydrin polymers and mixtures thereof.

47. The process according to claim 46, wherein the cationic polymer comprises (co)polymers of diallyldimethylammonium salts, (co)polymers of dimethylamine/epichlorohydrin, and mixtures thereof.

48. The process according to claim 43, wherein the cationic polymer has a concentration in the pre-mix of less than about 2.5%.

49. The process according to claim 48, wherein the cationic polymer has a concentration in the pre-mix of less than about 1.5%.

50. The process according to claim 49, wherein the cationic polymer has a concentration in the pre-mix of less than about 1.0%

51. The process according to claim 43, wherein the anionic particle is a high surface area anionically charged inorganic mineral, a high surface area anionically charged synthetic inorganic particle and mixtures thereof.

52. The process according to claim 51, wherein the anionic particle comprises swelling clay, sililca-based particles and mixtures thereof.

53. The process according to claim 52, wherein the silica-based particle comprises colloidal silica, colloidal aluminum-modified silica, aluminum silicate and mixtures thereof.

54. The process according to claim 52, wherein the swelling clay comprises bentonite, montmorillonite, montmorillinite, beidelite, nontronite, hectroite, saponite, sepialite or attapulgite.

55. The process according to claim 54, wherein the anionic particle is bentonite.

56. The process according to claim 52, wherein the swelling clay has a particle size ranging from about 1 nanometer to about 1 micrometer.

57. The process according to claim 52, where the swelling clay has a surface area of at least 50 m²/g.

58. The process according to claim 57, wherein the swelling clay has a surface area of at least 100 m²/g.

59. The process according to claim 58, wherein the swelling clay has a surface area of at least 200 m²/g.

60. The process according to claim 43, wherein the silica-based particle has a particle size below about 50 nanometers.

61. The process according to claim 60, wherein the silica-based particle has a particle size below about 20 nanometers.

62. The process according to claim 61, wherein the silica-based particle has a particle size ranging from about 1 to about 10 nanometers

63. The process according to claim 43, wherein the silica-based particle has a surface area of at least 50 m²/g.

64. The process according to claim 63, wherein the silica-based particle has a surface area of at least 100 m²/g.

65. The process according to claim 64, wherein the silica-based particle has a surface area of at least about 200 m²/g.

66. The process according to claim 43, wherein the stabilizing agent is nonionic or cationic.

67. The process according to claim 43 wherein the stabilizing agent comprises hydroxymethylhydroxyethyl cellulose, butylglycidylether modified hydroxyehtyl cellulose, hydroxypropyl cellulose, methylhydroxyethylcellulose, methylhydroxypropyl cellulose, methyl cellulose, ethyl cellulose, poly-N-vinylpyrolidone, polyvinyl alcohol, polyethylene oxide, polypropylene oxide, polyacrylamide, starch ethers, starch esters, oxidized starch, guar, pectin, carrageenan, locust bean gum, xanthan gum, water soluble proteins, hydrophobically associative paint thickeners, cationic starch, hydroxyethyl cellulose, hydroxypropyl guar and cationic guar.

68. The process according to claim 67, wherein the stabilizing agent comprises hydroxypropyl guar or hydroxyethylcellulose.

69. The process according to claim 68, wherein the stabilizing agent is hydroxypropyl guar.

70. The process according to claim 43,wherein the stabilizing agent is added in an amount of about 0.1% to about 5%, based on the total weight of the pre-mix.

71. The process according to claim 70,wherein the stabilizing agent is added in an amount of about 0.2% to about 1.0%, based on the total weight of the pre-mix.

72. The process according to claim 71,wherein the stabilizing agent is added in an amount of about 0.3% to about 0.7%, based on the total weight of the pre-mix.

73. The process according to claim 43, wherein the aqueous system has a viscosity of at least 1000 cps.

74. The process according to claim 73, wherein the aqueous system has a viscosity of at least 2000 cps.

75. The process according to claim 74, wherein the aqueous system has a viscosity of at least 3000 cps.

76. The process according to claim 43, wherein the aqueous system has a viscosity ranging from about 2000 to about 3500 cps.

77. A cellulose matrix coated according to the process of claim 44.

78. A process for preparing a stable pre-mix comprising:
(a) forming a pre-mix comprising an anionic particle and a cationic polymer;
(b) adding a stabilizing agent to the pre-mix, wherein a stable pre-mix is formed; and
(c) optionally adding a biocide to the pre-mix.

79. The process according to claim 78, wherein the cationic polymer comprises (co)polymers of diallyidialkylammonium salts; (co)polymers of diallylamine; (co)polymers of diallylalkylamine; polyethylene imine, (co)polymers of dialkylamine/epichlorohydrin; (co)polymers of polyamine/epichlorohydrin; (co)polymers of polyamide/epichlorohydrin; polymers of polyamideamine; (co)polymers of polyamideamine/epichlorohydrin; (co)polymers and quaternized (co)polymers of dialkylaminoalkyl acrylamide and methacrylamide; and (co)polymers, quaternized (co)polymers of dialkylaminoalkyl acrylate and methacrylate esters and mixtures thereof.

80. The process according to claim 79, wherein the cationic polymer comprises (co)polymers of diallyldimethylammonium salts; (co)polymers of polyamine/epichlorohydrin; polyethylene imine; (co)polymers of dimethylamine/epichlorohydrin; polyamideamine/epichlorohydrin polymers and mixtures thereof.

81. The process according to claim 80, wherein the cationic polymer comprises (co)polymers of diallyldimethylammonium salts, (co) polymers of dimethylamine/epichlorohydrin, and mixtures thereof.

82. The process according to claim 78, wherein the cationic polymer has a concentration in the pre-mix of less than about 2.5%.

83. The process according to claim 82, wherein the cationic polymer has a concentration in the pre-mix of less than about 1.5%.

84. The process according to claim 83, wherein the cationic polymer has a concentration in the pre-mix of less than about 1.0%

85. The process according to claim 78, wherein the anionic particle is a high surface area anionically charged inorganic mineral, a high surface area anionically charged synthetic inorganic particle and mixtures thereof.

86. The process according to claim 85, wherein the anionic particle comprises swelling clay, sililca-based particles and mixtures thereof.

87. The process according to claim 86, wherein the silica-based particle comprises colloidal silica, colloidal aluminum-modified silica, aluminum silicate and mixtures thereof.

88. The process according to claim 86, wherein the swelling clay comprises bentonite, montmorillonite, montmorillinite, beidelite, nontronite, hectroite, saponite, sepialite or attapulgite.

89. The process according to claim 88, wherein the anionic particle is bentonite.

90. The process according to claim 86, wherein the swelling clay has a particle size ranging from about 1 nanometer to about 1 micrometer.

91. The process according to claim 86, where the swelling clay has a surface area of at least 50 m²/g.

92. The process according to claim 91, wherein the swelling clay has a surface area of at least 100 m²/g.

93. The process according to claim 92, wherein the swelling clay has a surface area of at least 200 m²/g.

94. The process according to claim 86, wherein the silica-based particle has a particle size below about 50 nanometers.

95. The process according to claim 86, wherein the silica-based particle has a particle size below about 20 nanometers.

96. The process according to claim 95, wherein the silica-based particle has a particle size ranging from about 1 to about 10 nanometers

97. The process according to claim 86, wherein the silica-based particle has a surface area of at least 50 m²/g.

98. The process according to claim 97, wherein the silica-based particle has a surface area of at least 100 m²/g.

99. The process according to claim 98, wherein the silica-based particle has a surface area of at least about 200 m²/g.

100. The process according to claim 78, wherein the stabilizing agent is nonionic or cationic.

101. The process according to claim 78, wherein the stabilizing agent comprises hydroxymethylhydroxyethyl cellulose, butylglycidylether modified hydroxyehtyl cellulose, hydroxypropyl cellulose, methylhydroxyethylcellulose, methylhydroxypropyl cellulose, methyl cellulose, ethyl cellulose, poly-N-vinylpyrolidone, polyvinyl alcohol, polyethylene oxide, polypropylene oxide, polyacrylamide, starch ethers, starch esters, oxidized starch, guar, pectin, carrageenan, locust bean gum, xanthan gum, water soluble proteins and hydrophobically associative paint thickeners, cationic starch, hydroxyethyl cellulose, hydroxypropyl guar and cationic guar.

102. The process according to claim 101, wherein the stabilizing agent comprises hydroxypropyl guar or hydroxyethyl cellulose.

103. The process according to claim 102, wherein the stabilizing agent is hydroxypropyl guar.

104. The process according to claim 78,wherein the stabilizing agent is added in an amount of about 0.1% to about 5%, based on the total weight of the pre-mix.

105. The process according to claim 104,wherein the stabilizing agent is added in an amount of about 0.2% to about 1.0%, based on the total weight of the pre-mix.

106. The process according to claim 105,wherein the stabilizing agent is added in an amount of about 0.3% to about 0.7%, based on the total weight of the pre-mix.

107. The process according to claim 78, wherein the stable pre-mix has a viscosity of at least 1000 cps.

108. The process according to claim 107, wherein the stable pre-mix has a viscosity of at least 2000 cps.

109. The process according to claim 108, wherein the stable pre-mix has a viscosity of at least 3000 cps.

110. The process according to claim 78, wherein the stable pre-mix has a viscosity ranging from about 2000 to about 3500 cps.

111. A stable anionic particle/cationic polymer pre-mix produced according to the process of claim 78.
